(19) United States
(12) Patent Application Publication
(10) Pub. No.: US 2016/0137817 A1
(43) Pub. Date: May 19, 2016

(54) FLAME RETARDANT FIBRE-MATRIX SEMIFINISHED PRODUCTS

(71) Applicant: LANXESS Deutschland GmbH, Cologne (DE)

(72) Inventors: Jochen ENDTNER, Cologne (DE); Matthias BIENMUELLER, Krefeld (DE); Matthias ENZ, Ilshofen (DE)

(21) Appl. No.: 14/943,296

(22) Filed: Nov. 17, 2015

(30) Foreign Application Priority Data
Nov. 17, 2014 (EP) 14193396.0

(51) Int. Cl. C08K 5/5399; C08K 5/527

(52) U.S. Cl. CPC C08K 5/5399; C08K 5/527

(57) ABSTRACT

Flame retardant fibre-matrix semifinished products include a polycarbonate as the thermoplastic matrix material and may be used in components subject to increased flame retardancy requirements, such as casing materials for electrical or electronic parts, IT equipment such as flatscreen monitors, notebooks, mobile telephones or tablet computers, fittings for shielding, inter alia, short-circuit induced arc flash in circuit breakers, and flame barriers in buildings, passenger vehicles, commercial vehicles and in shipping applications and in means of public transport.

The invention relates to flame retardant fibre-matrix semifinished products comprising a polycarbonate thermoplastic matrix material and to the use thereof in components subject to increased flame retardancy requirements, preferably as casing materials for electrical or electronic parts, particularly preferably as casings for IT equipment, in particular in flatscreen monitors, notebooks, mobile telephones or tablet computers, as fittings for shielding, inter alia, short-circuit induced arc flash in circuit breakers and generally as a flame barrier in buildings, passenger vehicles, commercial vehicles, in shipping applications and in means of public transport, for example in rail vehicles and buses.

### BACKGROUND INFORMATION

Fibre-matrix semifinished products based on thermoplasts can represent a weight-saving alternative to materials such as aluminium, magnesium or steel alloys. In contrast to sheet metal, said products have the additional advantage of lower electrical conductivity which is particularly important in electrical or electronic component applications in particular.

Fibre-matrix semifinished products in the context of the present invention are light and rigid semifinished product sheets made of a thermoplastic matrix in which partially or completely impregnated long or endless fibres are embedded. While the fibres have a determining influence on the mechanical properties of the composite such as strength and stiffness, the matrix made of at least one thermoplast transmits the forces between the fibres, supports the fibres against buckling and protects said fibres from external attack. The fibres may, for example, be oriented in only one direction (unidirectional, for example as a tape), may run in two directions at right angles to one another (orthotropic or balanced) or may be placed at any desired angle to one another in quasi-isotropic fashion. Endless fibres have the advantage that they may be introduced into the thermoplast matrix in a highly extended state with a high degree of orientation and thus in relatively large amounts. Said fibres moreover permit force transmission between force application points within fibre-matrix semifinished products purely via the fibres, thus increasing the mechanical performance of a component based on such a fibre-matrix semifinished product.

A typical material of construction for the thermoplastic matrix of a fibre-matrix semifinished product is polycarbonate. In addition to very good impact strength, polycarbonate also has the advantage of producing very smooth and uniform surfaces which is an important consideration in particular for assemblies subject to demanding optical requirements. Being an amorphous thermoplast, polycarbonate is also highly transparent and allows the fibre matrix to be seen which is an aesthetic advantage, for example in applications for end-user casings, but also a concrete technical advantage since it is thus easier to recognize damage to the fibre matrix.

DE 41 16 800 A1 discloses an example of a fibre composite material of construction made of polycarbonate and satin weave carbon fibre fabric.

US 2009/0023351 A1 on the other hand describes flame retardant resin compositions and prepregs to be produced therefrom but does not disclose using polycarbonate as the thermoplast. By contrast, US 2013/0313493 A1 describes flame retardant polycarbonate compositions comprising short fibres made of glass, carbon or metal for injection moulding. EP 2 410 021 A1 also describes fibre-reinforced resin compositions which may be based on, inter alia, polycarbonate, may comprise glass fibres, carbon fibres or metal fibres as fillers and are for use in melt compounders.

A great disadvantage of fibre-matrix semifinished products comprising polycarbonate as the thermoplastic matrix polymer, particularly compared to materials made of metal, is the increased flammability which, in combination with the “wick effect” of the fibre material is a direct consequence of the flammability of the plastics material matrix employed. It is a typical characteristic of the wick effect in fibre-matrix semifinished products that the wick made of the fibre material does not itself burn but promotes the combustion of the organic thermoplast. This restricts the use of thermoplast-based fibre-matrix semifinished products particularly in fields of application subject to increased flame retardancy requirements, for example in the electrical and electronics sectors and in the field of IT but also in parts for means of public transport, for example ships, rail vehicles and buses. Thus in the electronics sector in particular approval is often only granted to materials classified in class V-0 as per UL94, i.e. no burning drips and rapidly self-extinguishing (Underwriters Laboratories Inc. Standard of Safety, “Test for Flammability of Plastic Materials for Parts in Devices and Appliances”, p. 14 to p. 18 Northbrook 2006). A further disadvantage is the difficulty of completely impregnating the fibre material with the polycarbonate matrix and thus obtaining a perfect bond between the thermoplast matrix and fibre matrix which, in turn, is the prerequisite for achieving the very high strengths and rigidities described at the outset. In contrast to moulding compounds where the thermoplast and the fibres may be intimately mixed with one another in a mixing apparatus, this option cannot be employed in the production of fibre-matrix semifinished products. Here, particular emphasis is placed on impregnating the fibre semifinished product composed of rovings. In the case of polycarbonate, a further aspect to be considered is the low stress-crack resistance thereof. The strength and rigidity of a fibre-matrix semifinished product based on polycarbonate may be negatively affected by contact with media in particular. However, stress-crack formation and failure-countering stress crack resistance is of essential importance for assessing the long-term performance of plastics materials and in the present case of the fibre-matrix semifinished products according to the invention, in particular under the action of a combination of media, temperature and high-energy radiation. Commensurate with this multiplicity of often complex influencing factors and the practical importance of stress-crack performance there are numerous standardized test methods in existence. These standards are primarily standards for test methods for finished parts.

In addition to these proficiency test methods, methods were developed for the field of development and optimization of materials of construction which allow characteristics determination using standardized specimens. The three most important methods are:
the tensile creep test according to DIN EN ISO 22088-2
the bent strip method according to DIN EN ISO 22088-3 and
the ball or pin impression method DIN EN ISO 22088-4

JP2014-091825 A2 teaches a polycarbonate-based carbon fibre prepreg where an improvement in impregnability is achieved by using a polycarbonate having a melt viscosity of from 1 to 100 Pas in combination with a unidirectional carbon fibre matrix. However a unidirectional fibre matrix restricts the field of application in terms of mechanical strength. This document moreover provides no solution for improving the flame retardancy properties.

JP2013-256616 A2 describes a three-stage process for improving impregnation comprising initially preimpregnating the reinforcing fibres in a solution comprising a specific polycarbonate copolymer, heating said fibres to expel the solvent and then pressing these preimpregnated reinforcing fibres with a polycarbonate film in alternating fashion. This process is considered very costly and inconvenient and moreover likewise provides no attempt at a solution for improving self-extinguishing performance.

However, there remains specific problems associated with fulfilling the particular flame retardancy requirements and impregnation procedures in fibre-matrix systems, in particular those based on glass fibre fabrics or carbon fibre fabrics, while retaining to the greatest extent possible the optical transparency typical of polycarbonate.

The problem addressed by the present invention is therefore that of providing a flame retardant fibre-matrix semifinished product based on polycarbonate which conforms to class V-0 as per UL94 and is free from halogen-containing flame retardants. As far as possible the additivization with the flame retardant system shall not impair the procedure for impregnating and consolidating the fibre material upon which the fibre-matrix semifinished products are based. Finally, the stress-crack resistance of fibre-matrix semifinished products according to the invention shall not be negatively affected by addition of flame retardants.

### DESCRIPTION

The solution to the problem and the subject-matter of the invention is a fibre-matrix semifinished product comprising
i) at least one fibrous material selected from the group of laids, wovens, formed-loop knits, braids, drawn-loop knits, nonwovens, rovings, mats, stitched fabrics and combinations thereof, made of glass fibres, carbon fibres, mineral fibres, natural fibres, polymeric fibres and/or combinations thereof, and
ii) a thermoplastic matrix comprising
   A) about 80 to about 97 wt %, preferably 75 to 90 wt %, particularly preferably 80 to 82 wt %, of at least one thermoplast from the group of polycarbonates, and
   B) about 3 to about 40 wt %, preferably 10 to 25 wt %, particularly preferably 18 to 20 wt %, of one or more phosphazenes of formula (I) and/or one or more phosphazenes of formula (II),

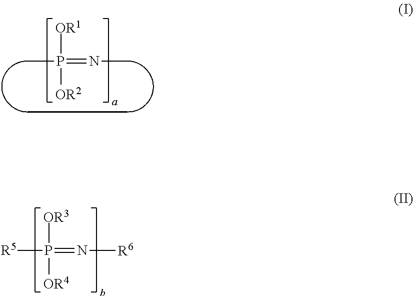

where
R¹, R² are identical or different and represent alkyl, cycloalkyl, aryl or alkylaryl,
R³, R⁴ are identical or different and represent alkyl, cycloalkyl, aryl or alkylaryl,
R⁵ represents —N═P(OR³)₃, —N═P(OR⁴)₃, —N═P(O)OR³ or —N═P(O)OR⁴,
R⁶ represents —N═P(OR³)₄, —N═P(OR⁴)₄, —N═P(O)(OR³)₂ or —N═P(O)(OR⁴)₂,
a is an integer in the range from about 3 to about 25, and
b is an integer in the range from 3 to 10 000,
   wherein the sum of the percentages by weight in the thermoplastic matrix ii) always amounts to 100 and wherein the fibrous material i) is impregnated with the thermoplastic matrix ii) and the volume fraction of the fibrous material i) in the fibre-matrix semifinished product is in the range from about 25 to about 65 vol %, preferably in the range from 30 to 60 vol %, particularly preferably in the range from 40 to 55 vol %.

Surprisingly, the polycarbonate-based fibre-matrix semifinished products imbued with flame retardancy in accordance with the invention exhibit a UL94 classification of V-0 coupled with very good mechanical characteristics.

It is noted for the avoidance of doubt that the scope of the present invention encompasses all below-referenced definitions and parameters referred to in general terms or within preferred ranges in any desired combinations, wherein specified ranges include ranges extending from end point to end point, from any value between the endpoints to either endpoint, or from any value between the endpoint to any other value between the endpoints.

It is further noted for the avoidance of doubt that in preferred embodiments the thermoplastic matrix ii) comprises compositions previously produced by mixing the components A) and B), which are to be used as reactants, in at least one mixing apparatus. These previously produced moulding compounds—also known as thermoplastic moulding compounds—may either be composed exclusively of the components A) and B) or else may contain, in addition to the components A) and 8), at least one further component, preferably at least one of the components C) to F). In this case at least one of the components A) or B) is to be varied within the scope of the specified ranges such that the sum of all percentages by weight based on the thermoplastic matrix ii) always amounts to 100.

Flexural strength in applied mechanics is the value for the flexural stress in a component under flexural load which when exceeded causes failure by fracture of the component. It describes the resistance that a workpiece offers to deflection or fracture. In the short-duration flexural test according to ISO 178, beam-shaped test pieces, here having the dimensions 80 mm·10 mm·203 mm, are placed with their ends on two supports and loaded in the centre with a flexing ram (Bodo Carlowitz: Tabellarische Übersicht Ober die Prüfung von Kunststoffen, 6th edition, Giesel-Verlag für Publizität, 1992, pp. 16-17).

According to “http://de.wikipedia.org/wiki/Biegeversuch” the flexural modulus is determined in a 3-point flexural test by positioning a test specimen on two supports and loading it in the centre with a test ram. For a flat specimen the flexural modulus is then calculated as follows:

E=Iᵥ³(X_{H}—X_{L})/4D_{L}ba³

where E=flexural modulus in kN/mm²; Iᵥ=distance between supports in mm; X_{H}=end of flexural modulus determination in kN; X_{L}=start of flexural modulus determination in kN; D_{L}=deflection in mm between X_{H} and X_{L}; b=sample width in mm; a=sample thickness in mm.

In the context of the present invention “alkyl” refers to a straight-chain or branched-chain saturated hydrocarbon group. In a number of embodiments an alkyl group comprising from 1 to 6 carbon atoms is employed and may be referred to as a “lower alkyl group”. Preferred alkyl groups are methyl (Me), ethyl (Et), propyl, in particular n-propyl and isopropyl, butyl, in particular n-butyl, isobutyl, sec-butyl, tert-butyl, pentyl groups, in particular n-pentyl, isopentyl, neopentyl, hexyl groups and the like.

In the context of the present invention “aryl” refers to a monocyclic aromatic hydrocarbon ring system or a polycyclic ring system comprising two or more fused aromatic hydrocarbon rings or at least one aromatic monocyclic hydrocarbon ring fused with one or more cycloalkyl and/or cycloheteroalkyl rings. An aryl group may have 6 to 24 carbon atoms in its ring system, for example a C₆₋₂₀ aryl group, and thus comprise a plurality of fused rings. In a number of embodiments aryl or arylene may denote a polycyclic aryl group comprising 8 to 24 carbon atoms. Preferred aryl groups comprising an aromatic carbocyclic ring system are phenyl, 1-naphthyl (bicyclic), 2-naphthyl (bicyclic), anthracenyl (tricyclic), phenanthrenyl (tricyclic), pentacenyl (penta) and similar groups. Other preferred aryl groups are benzodioxanyl, benzodioxolyl, chromanyl, indolinyl groups and the like. In a number of embodiments aryl groups, as described herein, may be substituted. In a number of embodiments an aryl group may have one or more substituents.

In the context of the present invention “cycloalkyl” refers to a nonaromatic carbocyclic group comprising cyclized alkyl, alkenyl or alkynyl groups. In various embodiments a cycloalkyl group comprises from 3 to 24 carbon atoms, preferably 3 to 20 carbon atoms, for example a C₃₋₁₄ cycloalkyl group. A cycloalkyl group may be monocyclic, for example cyclohexyl, or else polycyclic, as in bridged and/or spiro ring systems for example where the carbon atoms may be disposed inside or outside the ring system. Any suitable ring position of the cycloalkyl group may be bonded covalently to the defined chemical structure. Preferred cycloalkyl groups are cyclopropyl, cyclobutyl, cyclopntyl, cyclohexyl, cycloheptyl, cyclopentenyl, cyclohexenyl, cyclohexadienyl, cycloheptatrienyl, norbornyl, norpinyl, norcaryl, adamantyl and spiro[4.5]decanyl groups and their homologues, isomers and the like. In a number of embodiments the cycloalkyl groups may be substituted. Unsubstituted cycloalkyl groups are preferred in accordance with the invention.

In the context of the present invention “arylalkyl” denotes an alkyl-aryl group where the arylalkyl group is bonded covalently to the defined chemical structure via the alkyl group. An arylalkyl group preferred in accordance with the invention is the benzyl group (—CH₂—C₆H₅). Arylalkyl groups according to the present invention may optionally be substituted, i.e. either the aryl group and/or the alkyl group may be substituted.

The standards cited in this specification are applicated in their version at the filing date of the present patent application.

Fibre-matrix semifinished products, and the production and use thereof are known to those skilled in the art. Reference is made here merely to DE 19923480 A1, DE 20 2006 019341 U1, DE10 2009 051058 A1, DE 10 2010 053381 A1, DE 10 2011117338 A1, DE 10 2012 015438 A1 and DE 10 2012 111087 83.

Particularly preferred methods are batchwise production with static platen presses or continuous production with double wall presses as described in DE 41 15 800 A1 for example. Another option is the so-called film-stacking process which, improved by further development for the manufacturing scale, is elucidated for example in DE 41 04 692 A1.

The use of thermoplasts in the form of finely granular materials/powders for producing fibre composite material precursors (thermoplastic prepregs) was previously disclosed in DE 698 03 697 T2 which proposes using electrostatic impregnation to achieve homogeneous introduction of powder into the fibre layers. Furthermore, DE 691 30 111 T2 discloses the dry impregnation of a reinforcing material, which may be composed of fibres, for producing a composite. When fibre wovens or fibre braids, made of glass fibres, Kevlar fibres or carbon fibres for example, are embedded in a thermoplast matrix in defined orientations and pressed into sheets the fibre-matrix semifinished product for further fabrication of FRP components is obtained.

The forming of the thermoplastic fibre-matrix semifinished product required to achieve the subsequent component geometry may be carried out in the classical thermoforming process or in an injection moulding apparatus during closing of the injection mould employed therein.

The thermoforming process is used for producing three-dimensional moulded articles from sheetlike thermoplastic semifinished plastics products (films and sheets) by drawing in the theromoelastic material state (Herrlich, Land, Kunz, Michaeli, “Kunststoffprazis: Eigenschaften”, WEKA MEDIA Kissing, 2004, part 10 chapter 7.1 pages 1-5, part 10 chapter 7, 4 pages 1-2; Michaeli, “Einführung in die Kunststoffverarbeitung.pdf”, Carl Hanser Verlag, Munich 2010, pages 185-190).

The procedure for thermoforming fibre-matrix semifinished products comprises the following process steps (Industrievereinigung Verstärkte Kunststoffe, “Handbuch Faserverbund-Kunststoffe”, Vieweg+Teubner, Wiesbaden 2010, pages 477-482):
1. manual or automatic loading of the semifinished product into a retaining apparatus (tenter frame)
2. heating the semifinished product
3. forming the semifinished product
4. cooling the formed semifinished product
5. demoulding the formed semifinished product

However, the forming of the fibre-matrix semifinished product may also be performed in a press with subsequent transfer into an injection moulding apparatus.

Prior to further processing the formed fibre-matrix semifinished products may be hemmed or otherwise finished.

Fibre-matrix semifinished products, in particular those based on thermoplasts, are subdivided into the following groups (Schürmann, “Konstruieren mit Faser-Kunststoff-Verbunden”, Springer-Verlag Berlin Heidelberg 2005, 2007, pages 156-157):
long-fibre-reinforced systems:
   GMT: glass mat-reinforced thermoplasts;
   LFT: long-fibre-reinforced thermoplasts
a endless-fibre-reinforced systems

Depending on the production process and the differing degree of impregnation and consolidation resulting therefrom the following thermoplastic prepregs may be distinguished (“Faserverstärkte Kunsttsoffe verarbeiten”, Kunstsatoffe October 2003, Carl Hanser Verlag, pages 189-194):
textile/hybrid yarn prepregs: Production using textile processing methods from
   1. polymer fibres and reinforcing fibres or
   2. hybrid yarn
powder prepregs: Production via a powder scattering process
a solvent prepregs: Production via a solvent bath
a film and melt prepregs: Production via a pressing or laminating process using a melt or a film.

Prepreg is the abbreviation for preimpregnated fibres (American: preimpregnated fibers), see http://de.wikipedia.org/wiki/Prepreg. Prepreg refers to a semifinished product composed of long or endless fibres and a predried/prehardened but not yet polymerized thermosetting plastics material matrix and used primarily in lightweight construction. This term is also used in relation to a thermoplastic plastics material matrix in the context of the present application.

### Component i)

As fibrous material i) the fibre-matrix semifinished products according to the invention comprise at least one fibrous material selected from the group of laids, wovens, formed-loop knits, braids, drawn-loop knits, nonwovens, rovings, mats, stitched fabrics and combinations thereof, preferably mats, laids or wovens, particularly preferably wovens.

These fibrous materials are preferably composed of glass fibres, carbon fibres, mineral fibres, natural fibres, polymeric fibres and/or combinations thereof, particularly preferably of glass fibres or carbon fibres and/or combinations thereof, very particularly preferably of glass fibres.

The average fibre diameter is preferably in the range from 5 to 25 μm, particularly preferably in the range from 6 to 18 μm. A direct determination of weight and length, which is required for determining fibre fineness, is cited in DIN EN ISO 1973,[22]. This gravimetric test method (weighing method) comprises cutting fibre bundles comprising a defined number of fibres to a defined cut length and subsequently weighing said fibre bundles. The average fineness Tt of the fibres (in dtex) may be calculated from the weight m of the bundle in mg, the cut length I in mm and the number of fibres according to the relation

Fibre fineness Tt(in dtex)=10000·mass m(in mg)/[cut length l(in mm)·number of fibres Z].

See in this regard: http://de.wikipedia.org/wiki/Feinheit_(Textilien). Also described therein is the weight numbering according to the Tex system as per ISO1144 and DIN60905, part 1.

However, length and thickness of a single fibre may alternatively be determined in semiautomatic fashion with the aid of scanning electron micrographs (SEM) using a digitizer and computer-assisted data capture as described in EP 0399320 B2. The length and thickness distributions are then used to determine fibre volumes and fibre numbers per unit mass.

It is preferable to employ the following reinforcing fibres as continuous (endless) fibre reinforcement/long fibre reinforcement either on their own or in mixtures:
glass fibres (Oberbach, Baur, Brinkmann, Schmachtenberg, “Saechtling Kunststoff Taschenbuch”, Carl Hanser Verlag Munich Vienna 2004, pages 644-647),
metallized glass fibres,
carbon fibres (Oberbach, Baur, Brinkmann, Schmachtenberg, “Saechtling Kunststoff Taschenbuch”, Carl Hanser Verlag Munich Vienna 2004, page 648),
natural fibres, in particular linen fibres (Oberbach, Baur, Brinkmann, Schmachtenberg, “Saechtling Kunststoff Taschenbuch”, Carl Hanser Verlag Munich Vienna 2004, pages 650-652, 778-779),
polymeric fibres, in particular aramid fibres (Oberbach, Baur, Brinkmann, Schmachtenberg, “Saechtling Kunststoff Taschenbuch”, Carl Hanser Verlag Munich Vienna 2004, pages 648-650), preferably aramid fibres (Kunststoff-Handbuch, vol. 3/4, pages 106-107, Carl Hanser Verlag Munich Vienna 1998),
mineral fibres, in particular basalt fibres.

In a particularly preferred embodiment the fibre is in the form of an endless fibre.

According to DIN 60000 an endless fibre is a linear entity of practically unlimited length which may be subjected to textile processing. Synthetic fibres are referred to as filaments. DIN 60001 defines a filament as a fibre of at least 1000 mm in length.

The long fibre reinforcement or endless fibre reinforcement preferred in accordance with the invention is based on reinforcing textiles in the form of laids, wovens, formed-loop knits, braids, drawn-loop knits, mats, stitched fabrics and/or combinations thereof (“Maβgeschneiderte Verstärkungstextilien”, Kunstsatoffe June 2003, Carl Hanser Verlag, pages 46-49). Both glass rovings and glass filaments may be employed here. Glass ravings are generally provided with the final size before weaving while glass filaments are typically only treated with the final size after the weaving process. The size is an impregnating liquid which is applied as an adhesion promoter to textile threads/fibres, by spraying or immersing for example, prior to further processing. A sized thread or a sized fibre is smoother and more resistant to mechanical loads. Use of a size primarily seeks to achieve improved adhesion to the thermoplast to be employed in a fibre-matrix semifinished product. The endless fibre reinforcement may likewise be composed of nonwovens, fibre tows or rovings. Particular preference is given to wovens and laids, wovens being especially preferred. Wovens employed are preferably twill weave, satin weave and plain weave, particularly preferably twill weave and very particularly preferably 2/2 twill weave.

When employing carbon fibres it is preferable to use wovens made of 200 tex (3K), 400 tax (6K) or 800 tax (12K) filament yarns, wovens made of 200 tex (3K) filament yarns being particularly preferable. Here, 1K denotes that 1000 individual fibres have been combined into one yarn (in this regard see also: http://de.wikipedia.org/wiki/Kohlenstofffaser). Carbon fibre-based wovens preferred for employment in accordance with the invention have an average basis weight in the range from 50-1 000 g/m², particularly preferably in the range from 150 to 300 g/m².

In the case where glass fibres are employed which is preferred in accordance with the invention the wovens employed preferably have an average basis weight in the range from 300 to 1500 g/m², particularly preferably in the range from 450 to 1000 g/m², when using glass rovings and the wovens employed preferably have an average basis weight in the range from 50 to 800 g/m², particularly preferably in the range from 100 to 500 g/m² when using glass filaments. The present invention especially preferably relates to endless-fibre-reinforced fibre-matrix semifinished products.

In a particularly preferred embodiment of the present invention the fibrous materials i) are surface-modified, particularly preferably with an adhesion promoter/adhesion promoter system.

The carbon fibres preferred for employment in accordance with the invention may also be employed with or without an adhesion promoter. Preferred adhesion promoters here are based on urethane, epoxy or acrylate systems.

In the case of glass fibres which are very particularly preferred in accordance with the invention it is preferable to employ silane-based adhesion promoters/adhesion promoter systems. Silane-based adhesion promoters to be employed in accordance with the invention are described in EP 2468810 A1, the content of which is hereby fully incorporated by reference.

Particularly when using glass fibres it is preferable also to employ, in addition to silanes as adhesion promoters, polymer dispersions, emulsifiers, film formers (in particular polyepoxide, polyether, polyolefin, polyvinyl acetate, polyacrylate or polyurethane resins or mixtures thereof), branching agents, further adhesion promoters, lubricating agents, pH buffer substances and/or glass fibre processing aids (for example wetting agents and/or antistats). The further adhesion promoters, lubricating agents and other assistants, processes for producing the sizes and processes for coating and after treating the glass fibres are known to those skilled in the art and described, for example, in K. L. Löwenstein, “The Manufacturing Technology of Continuous Glass Fibres”, Elsevier Scientific Publishing Corp., Amsterdam. London, New York, 1983. The glass fibres may be sized by any desired methods, preferably using suitable apparatuses, in particular with spray or roller applicators. The glass filaments drawn at high speed from spinnerets may have size composed of adhesion promoter/adhesion promoter system applied to them immediately after their solidification, i.e. even before winding or cutting. However, it is also possible to size the fibres in an immersion bath composed of adhesion promoter/adhesion promoter system subsequent to the spinning process.

The glass fibres particularly preferred for employment in the fibrous material i) in accordance with the invention preferably have either a circular cross-sectional area and an average filament diameter in the range from 6 to 18 μm, preferably in the range from 9 to 17 μm, or a flat shape and noncircular cross-sectional area where the principal cross-sectional axis has an average width in the range from 6 to 40 μm and the secondary cross-sectional axis has an average width in the range from 3 to 20 μm. The glass fibres are preferably selected from the group of E-glass fibres, A-glass fibres, C-glass fibres, D-glass fibres, S-glass fibres and/or R-glass fibres, particular preference being given to E-glass.

The fibres are in particular finished with a suitable silane-based size system/adhesion promoter/adhesion promoter system.

Particularly preferred silane-based adhesion promoters for the pretreatment of the glass fibres are silane compounds of general formula (III)

(X—(CH₂)_{q})ₖ—Si—(O—CᵣH₂ᵣ₊₁)₄₋ₖ (III)

where the substituents are defined as follows:
X represents NH₂—, HO or

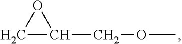

q is an integer from 2 to 10, preferably 3 or 4,
r is an integer from 1 to 5, preferably 1 or 2 and
k is an integer from 1 to 3, preferably 1.

Very particularly preferred adhesion promoters are monomeric organofunctionai silanes, in particular 3-aminopropyltrimethoxysilane, aminobutyltrimethoxysilane, 3-aminopropyltriethoxysilane, aminobutyltriethoxysilane, 3-aminopropyltrismethoxyethoxysilane, 3-aminopropylmethyldiethoxysilane, N-methyl-2-aminoethyl-3-aminopropyltrimethoxysilane, N-methyl-2-aminoethyl-3-aminopropylmethyldimethoxysilane, N-methyl-3-aminopropyltrimethoxysilane, 3-glycidyloxypropyltrimethoxysilane, 3-methacryloxypropyltrimethoxysilane, 3-mercaptopropyltrimethoxysilane, vinyltriethoxysilane, vinyltrimethoxysilane, N-β-(aminoethyl)-γ-aminopropyltrimethoxysilane (Dynasilan Demo from Hüls AG), N-β-(aminoethyl)-γ-aminopropyltriethoxysilane, N-β-aminoethyl)-γ-aminopropylmethyldimethoxysilane, N-β-(aminoethyl)-N-β-(aminoethyl)-γ-aminopropyltrimethoxysilane.

The silane compounds are generally used in amounts in the range from 0.05 to 5 wt %, preferably in the range from 0.1 to 1.5 wt % and in particular in amounts in the range from 0.25 to 1 wt %, based on the filler, for surface coating.

In accordance with the invention the volume fraction of the fibrous material i) in the fibre matrix semifinished product is preferably in the range from 30 to 64 vol %, particularly preferably in the range from 40 to 55 vol %.

### Component ii)

### Component A) Polycarbonate

As component A) the thermoplastic matrix ii) comprises at least one thermoplast from the group of polycarbonates. This may also be a mixture of polycarbonates.

Polycarbonates preferred for employment in accordance with the invention are homopolycarbonates and copolycarbonates based on the bisphenols of general formula (IV)

HO—Z—OH (IV)

where Z is a divalent organic radical comprising 6 to 30 carbon atoms and one or more aromatic groups.

It is preferable to employ polycarbonates based on bisphenols of formula (IVa)

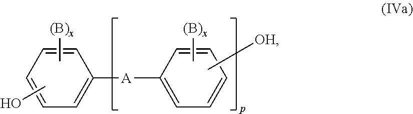

where
A represents a single bond or a radical from the set C₁-C₆ alkylene, C₂-C₅ alkylidene, C₅-C₆ cycloalkylidene, —O—, —SO—, —CO—, —S—, —SO₂—, C₆-C₁₂ arylene, onto which further aromatic rings optionally containing heteroatoms may be fused,
or A represents a radical of formula (V) or (VI)

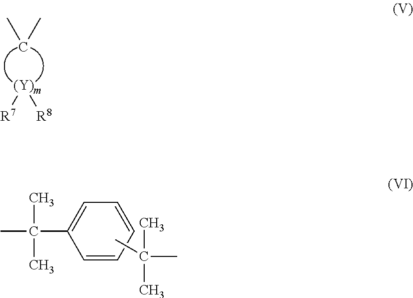

R⁷ and R⁸ are individually selectable for each Y and independently of one another represent hydrogen or C₁-C₆ alkyl, preferably hydrogen, methyl or ethyl,
B in each case represents C₁-C₁₂ alkyl, preferably methyl, halogen, preferably chlorine and/or bromine,
x is in each case independently of one another 0, 1 or 2,
p is 1 or 0 and
Y represents carbon,
m is an integer from 4 to 7, preferably 4 or 5, with the proviso that on at least one Y (carbon atom) R⁷ and R⁸ simultaneously represent alkyl,

When m is 4, Y represents —CR⁷R⁸—CR⁷R⁸—CR⁷R⁸—CR⁷R⁸—.

When m is 5, Y represents —CR⁷R⁸—CR⁷R⁸—CR⁷R⁸—CR⁷R⁸—CR⁷R⁸—,

When m is 6, Y represents —CR⁷R⁸—CR⁷R⁸—CR⁷R⁸—CR⁷R⁸—CR⁷R⁸—CR⁷R⁸—.

When m is 7, Y represents —CR⁷R⁸—CR⁷R⁸—CR⁷R⁸—CR⁷R⁸—CR⁷R⁸—CR⁷R⁸—CR⁷R⁸—.

Preferred bisphenols comprising general formula (V) are bisphenols from the group dihydroxydiphenyls, bis(hydroxyphenyl)alkanes, bis(hydroxyphenyl)cycloalkanes, indanebisphenols, bis(hydroxyphenyl) sulphides, bis(hydroxyphenyl) ethers, bis(hydroxyphenyl) ketones, bis(hydroxyphenyl) sulphones, bis(hydroxyphenyl) sulphoxides and α,α′-bis(hydroxyphenyl)diisopropylbenzenes.

Bisphenols comprising general formula (V) which are preferred for employment also include derivatives of the cited bisphenols obtainable, for example, by alkylation or halogenation at the aromatic rings of the cited bisphenols.

Particularly preferred bisphenols comprising the general formula (V) are hydroquinone, resorcinol, 4,4′-dihydroxydiphenyl, bis(4-hydroxyphenyl)sulphide, bis(4-hydroxyphenyl)sulphone, bis(3,5-dimethyl-4-hydroxyphenyl)methane, bis(3,5-dimethyl-4-hydroxyphenyl)sulphone, 1,1-bis(3,5-dimethyl-4-hydroxyphenyl)-p/m-diisopropylbenzene, 1,1-bis(4-hydroyphenyl)-1-phenylethane, 1,1-bis(3,5-dimethyl-4-hydroxyphenyl)cyclohexane, 1,1-bis(4-hydroxyphenyl)-3-methylcyclohexane, 1,1-bis(4-hydroxyphenyl)-3,3-dimethylcyclohexane, 1,1-bis(4-hydroxyphenyl)-4-methylcyclohexane, 1,1-bis(4-hydroxyphenyl)cyclohexane, 1,1-bis(4-hydroxyphenyl)-3,3,5-trimethylcyclohexane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)propane (i.e. bisphenol A), 2,2-bis(3-chloro-4-hydroxyphenyl)propane, 2,2-bis(3,5-dibromo-4-hydroxyphenyl)propane, 2,4-bis(4-hydroxyphenyl)-2-methylbutane, 2,4-bis(3,5-dimethyl-4-hydroxyphenyl)-2-methylbutane, α,α′-bis(4-hydroxyphenyl)-o-diisopropylbenzene, α,α′-bis(4-hydroxyphenyl)-m-diisopropylbenzene (i.e. bisphenol M), α,α′-bis(4-hydroxyphenyl)-p-diisopropylbenzene and indane bisphenol.

The described bisphenols according to general formula (V) may be produced according to known processes, for example from the corresponding phenols and ketones.

The cited bisphenols and processes for the production thereof are described, for example, in the monograph H. Schnell, “Chemistry and Physics of Polycarbonates”, Polymer Reviews, volume 9, pp. 77-98, Interscience Publishers, New York, London, Sidney, 1964 and in U.S. Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in U.S. Pat. No. 4,982,014, in U.S. Pat. No. 2,999,846, in DE-A 1 570 703, in DE-A 2 063 050, in DE-A 2 036 052, in DE-A 2 211 956, in DE-A 3 832 396 and in FR-A 1 5681 518, and also in the published Japanese patent applications having application numbers JP-A 62039 1986, JP-A 62040 1986 and JP-A 105550 1986.

1,1-bis(4-hydroxyphenyl)-3,3,5-trimethylcyclohexane and the production thereof is described in U.S. Pat. No. 4,982,014 for example.

Indane bisphenols and the production thereof are described in U.S. Pat. No. 3,288,864, in JP-A 60 035 150 and in U.S. Pat. No. 4,334,106 for example, Indane bisphenols may be produced, for example, from isopropenylphenol or derivatives thereof or from dimers of isopropenylphenol or derivatives thereof in the presence of a Friedel-Craft catalyst in organic solvents.

The polycarbonates to be employed as component A) may also be produced according to known processes. Examples of suitable processes for producing polycarbonates include production from bisphenols with phosgene according to the interfacial process or from bisphenols with phosgene according to the homogeneous process, the so-called pyridine process, or from bisphenols and carbonate esters according to the melt transesterification process. These production processes are described, for example, in H, Schnell, “Chemistry and Physics of Polycarbonates”, Polymer Reviews, Volume 9, pp. 31-76, Interscience Publishers, New York, London, Sidney, 1964. The cited production processes are also described in D. Freitag, U. Grigo, P. R. Müller, H. Nouvertne, “Polycarbonates” in Encyclopedia of Polymer Science and Engineering, volume 11, second edition, 1988, pages 648 to 718 and in U. Grigo, K. Kircher and P. R. Müller “polycarbonate” in Becker, Braun, Kunststoff-Handbuch, volume 3/1, Polycarbonate, Polyacetale, Polyester, Celluloseester, Carl Hanser Verlag Munich, Vienna 1992, pages 117 to 299 and in D. C. Prevorsek, B. T. Debona und Y. Kesten, Corporate Research Center, Allied Chemical Corporation, Morristown, N.J. 07960, “Synthesis of Poly(estercarbonate) Copolymers” in Journal of Polymer Science, Polymer Chemistry Edition, vol. 19, 75-90 (1980).

The melt transesterification process is in particular described, for example, in H. Schnell, “Chemistry and Physics of Polycarbonates”, Polymer Reviews, volume 9, pp. 44 to 51, Interscience Publishers, New York, London, Sidney, 1964 and in DE-A 1 031 512.

In the production of polycarbonate it is preferable to employ feedstocks and assistants comprising a low level of impurities. In particular, in production according to the melt transesterification process the bisphenols employed and the carbonic acid derivatives employed shall be free from alkali metal ions and alkaline earth metal ions to the greatest possible extent. Such pure feedstocks are obtainable, for example, by recrystallizing, washing or distilling the carbonic acid derivatives, for example carbonate esters, and the bisphenols.

The polycarbonates to be employed in accordance with the invention preferably have a weight-average molar mass (M;_w), determinable, for example, by ultracentrifugation (see K. Schilling, Analytische Ultrazentrifugation, Nanolytics GmbH, Dallgow) or light scattering according to DIN EN ISO 16014-5:2012-10, in the range from 10 000 to 200 000 g/mol. It is particularly preferable when said polycarbonates have a weight-average molar mass in the range from 12 000 to 80 000 g/mol and it is especially preferable when said polycarbonates have a weight-average molar mass in the range from 20 000 to 35 000 g/mol,

The average molar mass of the polycarbonates to be employed in accordance with the invention may be adjusted in known fashion using an appropriate amount of chain terminators for example. The chain terminators may be employed individually or as a mixture of different chain terminators.

Preferred chain terminators include both monophenols and monocarboxylic acids. Preferred monophenols are phenol, p-chlorophenol, p-tert-butylphenol, cumylphenol and 2,4,6-tribromophenol and also long-chain alkylphenols, in particular 4-(1,1,3,3-tetramethylbutyl)phenol or monoalkylphenols/dialkylphenols comprising a total of 8 to 20 carbon atoms in the alkyl substituents, in particular 3,5-di-tert-butylphenol, p-tert-octylphenol, p-dodecylphenol, 2-(3,5-dimethylheptyl)phenol or 4-(3,5-dimethylheptyl)phenol. Preferred monocarboxylic acids are benzoic acid, alkyl benzoic acids and halogenobenzoic acids.

Particularly preferred chain terminators are phenol, p-tert-butylphenol, 4-(1,1,3,3-tetramethylbutyl)phenol or cumylphenol.

The amount of chain terminators to be employed is preferably in the range from 0.25 to 10 mol % based on the sum of the bisphenols used in each case.

The polycarbonates to be employed as component A) in accordance with the invention may be branched in known fashion and preferably by incorporation of trifunctional or more than trifunctional branching agents. Preferred branching agents comprise three or more than three phenolic groups or three or more than three carboxylic acid groups.

Particularly preferred branching agents are phloroglucinol, 4,6-dimethyl-2,4,6-tri(4-hydroxyphenyl)-2-heptene, 4,6-dimethyl-2,4,6-tri(4-hydroxyphenyl)heptane, 1,3,5-tri(4-hydroxyphenyl)benzene, 1,1,1-tris(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, 2,5-bis(2-hydroxy-5-methylbenzyl)-4-methylphenol 2-(4-hydroxyphenyl)-2-(2,4-dihydroxyphenyl)propane, hexa-(4-(4-hydroxyphenylisopropyl)phenyl)terephthalate, tetra(4-hydroxyphenyl)methane, tetra(4-(4-hydroxyphenylisopropyl)phenoxy)methane and 1,4-bis(4′,4″-dihydroxytriphenyl)methylbenzene, 2,4-dihydroxybenzoic acid, trimesic acid, cyanuric chloride, 3,3-bis(3-methyl-4-hydroxyphenyl)-2-oxo-2,3-dihydroindole, trimesic acid trichloride or α,α′,α″-tris(4-hydroxyphenol) 1,3,5-triisopropylbenzene.

Very particular preference is given to the branching agents 1,1,1-tris(4-hydroxyphenyl)ethane or 3,3-bis(3-methyl-4-hydroxyphenyl)-2-oxo-2,3-dihydroindole.

The amount of the branching agent to be employed in one embodiment is preferably in the range from 0.05 mol % to 2 mol % based on moles of bisphenols employed.

In the case of production of the polycarbonate according to the interfacial process for example the branching agents may be initially charged with the bisphenols and the chain terminators in the aqueous alkaline phase or may be added dissolved in an organic solvent together with the carbonic acid derivatives. In the case of the transesterification process the branching agents are preferably added together with the dihydroxyaromatics or bisphenols.

Catalysts preferred for employment in the production according to the melt transesterification process of polycarbonate to be employed as component A) in accordance with the invention are ammonium salts and phosphonium salts as described in U.S. Pat. No. 3,442,864, JP-A-14742/72, U.S. Pat. No. 5,399,659 and DE-A 19 539 290 for example.

It is also possible to employ copolycarbonates as component A), In the context of the invention copolycarbonates are in particular polydiorganosiloxane-polycarbonate block copolymers having a weight-average molar mass (M;_w) which is preferably in the range from 10 000 to 200 000 g/mol, particularly preferably in the range from 20 000 to 80 000 g/mol, as determined by gel chromatography according to DIN EN ISO 16014-5:2012-10 after prior calibration by light scattering or ultracentrifugation. The content of aromatic carbonate structural units in the polydiorganosiloxane-polycarbonate block copolymers is preferably in the range from 75 to 97.5 wt %, particularly preferably in the range from 85 to 97 wt %. The content of polydiorganosiloxane structural units in the polydiorganosiloxane-polycarbonate block copolymers is preferably in the range from 25 to 2.5 wt %, particularly preferably in the range from 15 to 3 wt %. The polydiorganosiloxane-polycarbonate block copolymers may preferably be produced from α,ω-bishydroxyaryloxy end group-containing polydiorganosiloxanes having an average degree of polymerization Pₙ in the range from 5 to 100, particularly preferably having an average degree of polymerization Pₙ in the range from 20 to 80.

Polycarbonates particularly preferred for employment as component A) are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

The polycarbonates to be employed as component A) may have customary additives, in particular demoulding agents, added to them in the melt or applied to them on the surface. It is preferable when the polycarbonates employed as component A) already comprise demoulding agents prior to compounding with the other components of the thermoplastic matrix ii).

The person skilled in the art understands compounding to mean the plastics-industry term for improving plastics materials by admixing added substances (fillers, additives etc.) for targeted optimization of property profiles. Compounding is preferably performed in extruders, particularly preferably in corotating twin-screw extruders, counterrotating twin-screw extruders, planetary screw extruders or cocompounders and comprises the process operations conveying, melting, dispersing, mixing, degassing and pressure build-up.

Component B) In accordance with the invention the thermoplastic matrix ii) comprises as component B) one or more organic phosphazenes of formula (I) and/or one or more phosphazenes of formula (II). The phosphazenes and the preparation thereof are described, for example, in EP-A 728 811, DE-A 1961668 and WO97/40092.

It is preferable when R¹, R², R³ and R⁴ represent aryl and/or alkylaryl. Preferably employed aryl groups are those comprising 6-20 carbon atoms, in particular phenyl, methylphenyl, dimethylphenyl, trimethylphenyl and/or naphthyl. Very particular preference is given to aryls comprising 6-10 carbon atoms, phenyl being especially very particularly preferred. Alkylaryl groups employed are preferably those comprising 6-20 carbon atoms, benzyl, phenylethyl and phenylpropyl being particularly preferred and benzyl being very particularly preferred.

In accordance with the invention cyclic phosphazenes of formula (I) and/or straight-chain phosphazenes of formula (II) are employed. The cyclic phosphazenes of formula (I) to be employed in accordance with the invention are preferably those where a in formula (I) is an integer in the range from 3 to 8, particularly preferably an integer in the range from 3 to 5.

The straight-chain phosphazenes of formula (II) to be employed in accordance with the invention are preferably those where b is an integer in the range from 3 to 1000, particularly preferably in the range from 3 to 100, very particularly preferably in the range from 3 to 25.

Especially very particularly preferred in accordance with the invention is the use as component B) of cyclic phenoxyphosphsphazenes, which are available, for example, from Fushimi Pharmaceutical Co. Ltd, Kagawa, Japan as Rabitle® FP110 [CAS No. 1203646-63-2] or when a=3 2,2,4,4,6,6-hexahydro-2,2,4,4,6,6-hexaphenoxytriazatriphosphorines [CAS No. 1184-10-7].

### Component C)

One preferred embodiment also employs, in addition to the components A) and B), component C) 0.001 to 2 wt %, preferably 0.01 to 1 wt %, particularly preferably 0.02 to 0.5 wt %, of at least one thermal stabilizer from the group of aliphatically or aromatically substituted phosphites, wherein at least one of the components A) or B) is to be varied within the scope of the specified ranges such that the sum of all percentages by weight for the components A), B) and C) based on the thermoplastic matrix ii) always amounts to 100.

The molecular weight of the thermal stabilizer to be employed as component C) is preferably greater than 650 g/mol. In the context of the present invention aliphatically substituted phosphites comprising a structural building block of formula (VII) where R⁹ represents substituted aryl radicals which may be identical or different from one another are comprehended and preferred.

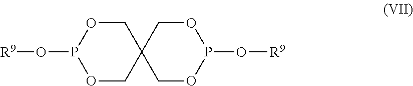

A particularly preferably employed aliphatically substituted phosphite is bis(2,4-dicumylphenyl)pentaerythritol diphosphite [CAS No. 54862-43-8] which is available, for example, from Dover Chemical Corp., Dover, USA under the trade name Doverphos® S9228.

Among the exclusively aromatically substituted phosphites it is particularly preferable in accordance with the invention to employ tetrakis(2,4-di-tert-butylphenyl)-1,1-biphenyl-4,4′-diylbisphosphonite [CAS No. 38613-77-3] obtainable, for example, as Hostanox® P-EPQ from Clariant International Ltd., Multenz, Switzerland.

Component D) In a further preferred embodiment the thermoplastic matrix ii) also comprises, in addition to components A) to C) or in place of C), D) 0.001 to 3 wt %, preferably 0.01 to I wt %, very particularly preferably 0.02 to 0.5 wt %, of at least one thermal stabilizer selected from the group of sterically hindered phenols, wherein said phenols are compounds having a phenolic structure which comprise at the phenolic ring at least one sterically demanding group and wherein the sum of all the percentages by weight for the components A), B), C), D) or A), B), D) based on the thermoplastic matrix ii) always amounts to 100.

Preferred sterically hindered phenols are compounds comprising at least one molecular building block of formula (IX),

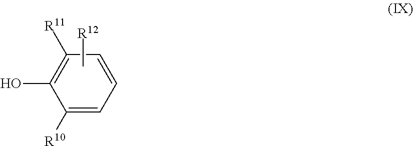

where R¹⁰ and R¹¹ represent an alkyl group, a substituted alkyl group or a substituted triazole group, wherein the radicals R¹⁰ and R¹¹ may be identical or different and R¹² represents an alkyl group, a substituted alkyl group or an optionally substituted alkoxy group.

In organic chemistry steric hindrance describes the influence of the spatial extent of a molecule on the progress of the reaction. The term describes the fact that some reactions proceed only very slowly, if at all, when large and bulky groups are present in the vicinity of the reacting atoms. One well-known example of the influence of steric hindrance is the reaction of ketones in a Grignard reaction. When di-tert-butyl ketone is employed in the reaction the very bulky tert-butyl groups retard the reaction to such an extent that no more than a methyl group may be introduced, larger radicals no longer react at all.

One group of sterically hindered phenols particularly preferred for employment derives from substituted benzenecarboxylic acids, in particular from substituted benzenepropionic acids. Particularly preferred compounds of this class are compounds of formula (X)

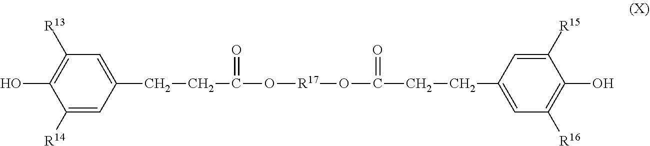

where R¹³, R¹⁴, R¹⁵ and R¹⁶ are each independently of one another C₁-C₈ alkyl groups which may themselves be substituted (at least one of these is a sterically demanding group) and R¹⁷ is a divalent aliphatic radical comprising 1 to 15 carbon atoms which may also comprise C—O bonds and branches in the main chain. Preferred embodiments of compounds of formula (X) are compounds of formulae (XI), (XII) and (XIII).

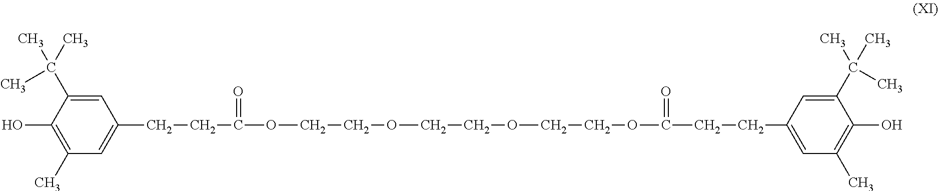 [SMILES: Cc1cc(CCC(=O)OCCOCCOCCOC(=O)CCc2cc(C)c(O)c(C(C)(C)C)c2)cc(C(C)(C)C)c1O]

Formula (XI) is Irganox® 245 from BASF SE, [CAS No. 36443-58-2] which has the chemical name triethylene glycol bis(3-tert-butyl-4-hydroxy-5-methylphenyl)propionate.

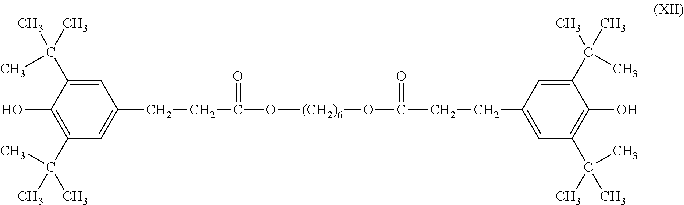

Formula (XII) is Irganox® 259 from BASF SE, [CAS No. 35074-77-2] which has the chemical name 1,6-hexamethylene bis(3,5-di-(tert)-butyl-4-hydroxyhydrocinnamate.

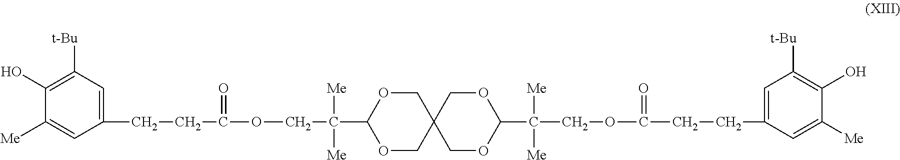 [SMILES: Cc1cc(CCC(=O)OCC(C)(C)C2OCC3(CO2)COC(C(C)(C)COC(=O)CCc2cc(C)c(O)c(C(C)(C)C)c2)OC3)cc(C(C)(C)C)c1O]

Formula (XIII) is ADK stabilizator AO 80 from Adeka Palmerole SAS, [CAS No. 90498-90-1] which has the chemical name 3,9-bis(2-(3-(3-tert-butyl-4-hydroxy-5-methylphenyl)propionyloxy-1,1-dimethyl)-2,4,8,10-tetraoxaspiro[5.5]undecane.

Thermal stabilizers very particularly preferred for employment as component D) are those having a molecular weight above 600 g/mol. These are especially very preferably selected from the group 1,6-hexanediol bis[3-(3,5-di-tert-butyl-4-hydroxyphenyl)propionate][CAS No. 35074-77-2] (Irganox® 259), pentaerythritol tetrakis[3-(3,5-di-tert-butyl-4-hydroxyphenyl)propionate][CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,0-tetraoxaspiro[5.5]undecane [CAS No. 90498-90-1] (ADK Stab® AO 80), the latter being most preferred. ADK Stab® AO 80 is commercially available from Adeka-Palmerole SAS, Mulhouse, France.

### Component E)

In a further preferred embodiment the thermoplastic matrix ii) also comprises, in addition to the components A) to D) or in place of C) and/or D), E) 0.01 to 5 wt %, preferably 0.05 to 1 wt %, very particularly preferably 0.1 to 0.6 wt %, of at least one lubricating and demoulding agent selected from the set of long-chain fatty acids, the salts of long-chain fatty acids, the ester derivatives of long-chain fatty acids, montan waxes and low molecular weight polyethylene/polypropylene waxes, wherein the sum of all the percentages by weight for the components A), B), C), D), E) or A), B), D), E) or A), B), C), E) or A), B), E) based on the thermoplastic matrix ii) amount to 100.

Preferred long-chain fatty acids are stearic acid or behenic acid. Preferred salts of the long-chain fatty acids are calcium or zinc stearate. A preferred ester derivative of long-chain fatty acids is pentaerythritol tetrastearate.

Montan waxes in the context of the present invention are mixtures of straight-chain saturated carboxylic acids having chain lengths of from 28 to 32 carbon atoms. Particularly preferably employed in accordance with the invention are lubricating and/or demoulding agents from the group of esters of saturated or unsaturated aliphatic carboxylic acids comprising 8 to 40 carbon atoms with aliphatic saturated alcohols comprising 2 to 40 carbon atoms and metal salts of saturated or unsaturated aliphatic carboxylic acids comprising 8 to 40 carbon atoms, pentaerythritol tetrastearate, calcium stearate [CAS No. 1592-23-0] and/or ethylene glycol dimontanate, in particular Licowax® E [CAS No. 74388-22-0] from Clariant, Muttenz, Basle, being very particularly preferred and pentaerythritol tetrastearate [CAS No, 115-83-3], for example obtainable as Loxiol® P861 from Emery Oleochemicals GmbH, Düsseldorf, Germany, being especially very particularly preferred.

### Component F)

In a further preferred embodiment the thermoplastic matrix ii) also comprises, in addition to the components A) to E) or in place of C) and/or D) and/or E), F) 0.01 to 75 wt %, preferably 0.1 to 50 wt %, very particularly preferably 0.2 to 25 wt %, in each case based on the total composition of the thermoplastic matrix ii), of at least one further additive which is distinct from the components B), C), D) and E), wherein the sum of all the percentages by weight for the components A), B), C), D), E), F) or A), B), D), E), F) or A), B)), C), E), F) or A), B), C), D), F) or A), B), E), F) or A), B). C), F) or A), B), D), F) or A), B), E), F) or A), B), F) based on the thermoplastic matrix ii) always amounts to 100.

In the case where component F) is employed this may have consequences for the transparency criterion established for the fibre-matrix semifinished product and, consequently, for the articles of manufacture to be produced therefrom. Those skilled in the art would therefore consider employing component F) only after taking these consequences into account, in particular when, instead of transparency, other criteria—such as flame retardancy alone—have priority with respect to the articles of manufacture to be produced from the fibre-matrix semifinished products according to the invention.

Under this precondition, preferred further additives in the context of the present invention are UV stabilizers, further halogen-free flame retardants, further lubricating and demoulding agents distinct from component E), further thermal stabilizers distinct from components C) and D), also fillers and reinforcers, laser absorbers, di- or polyfunctional branching or chain-extending additives, gamma-ray stabilizers, hydrolysis stabilizers, acid scavengers, antistats, emulsifiers, plasticizers, processing aids, flow assistants, elastomer modifiers and colourants. The respective additives may be used alone or in a mixture/in the form of masterbatches.

Preferably employed UV stabilizers are substituted resorcinols, salicylates, benzotriazoles, triazine derivatives and benzophenones.

Preferably employed colourants are organic pigments, preferably phthalocyanines, quinacridones, perylenes and dyes, preferably nigrosin or anthraquinones, also inorganic pigments, in particular titanium dioxide, ultramarine blue, iron oxide, zinc sulphide and carbon black. Useful as the titanium dioxide preferred for employment in accordance with the invention, are titanium dioxide pigments whose basic structures may be produced by the sulphate (SP) or chloride (CP) process and which have the anatase and/or rutile structure, preferably the rutile structure. The basic structure need not be stabilized, but preference is given to a specific stabilization: for the CP basic structure by Al doping of 0.3-3.0 wt % (calculated as Al₂O₃) and an oxygen excess in the gas phase in the oxidation of titanium tetrachloride to titanium dioxide of at least 2%; for the SP basic structure by doping, for example, with Al, Sb, Nb or Zn. To retain sufficient brightness of the articles of manufacture to be produced from the compositions according to the invention it is particularly preferable when preference is given to “light” stabilization with Al and compensation with antimony in case of greater amounts of Al doping. It is known that when using titanium dioxide as white pigment in paints and coatings, plastics materials etc, unwanted photocatalytic reactions caused by UV absorption lead to decomposition of the pigmented material. The titanium dioxide pigments absorb light in the near-ultraviolet range thus forming electron-hole pairs which generate highly reactive free radicals on the titanium dioxide surface. The free radicals formed result in binder degradation in organic media. In accordance with the invention the photoactivity of the titanium dioxide is preferably reduced by inorganic aftertreatment of said dioxide, particularly preferably with oxides of Si and/or Al and/or Zr and/or through the use of Sn compounds.

It is preferable when the surface of titanium dioxide pigment has a covering of amorphous precipitated oxide hydrates of the compounds SiO₂ and/or Al₂O₃ and/or zirconium oxide. The Al₂O₃ shell facilitates pigment dispersion in the polymer matrix and the SiO₂ shell impedes charge exchange at the pigment surface and hence prevents polymer degradation.

In accordance with the invention the titanium dioxide is preferably provided with hydrophilic and/or hydrophobic organic coatings, in particular with siloxanes or polyalcohols.

Titanium dioxide preferred for employment in accordance with the invention as component F) [CAS No. 13463-67-7] preferably has a median particle size d50 in the range from 90 nm to 2000 nm, preferably in the range from 200 nm to 800 nm. The median particle size d50 is the value determined from the particle size distribution at which 50 wt % of the particles have an equivalent sphere diameter smaller than this d50 value. The underlying standard is ISO 13317-3.

In the context of the present invention the values for the particle size distribution and for the particle sizes relate to so-called area-based particle sizes in each case prior to incorporation into the thermoplastic moulding compound. Particle size determination is performed in accordance with the invention by laser diffractometry, see C. M. Keck, Moderne Pharmazeutische Technologie 2009, Freie Universität Berlin, Chapter 3.1. or QUANTACHROME PARTIKELWELT NO 6, June 2007, pages 1 to 16.

Examples of commercially available titanium dioxide include Kronos® 2230, Kronos® 2233, Kronos® 2225 and Kronos® vlp7000 from Kronos, Dallas, USA.

Preferably employed acid scavengers are hydrotalcite, chalk, boehmite and zinc stannate.

Preferred fillers and reinforcers distinct from the fibrous materials i) according to the invention are selected from the group mica, silicate, quartz, wollastonite, kaolin, amorphous silicas, nanoscale minerals, in particular montmorillonite or nanoboehmite, magnesium carbonate, chalk, feldspar, barium sulphate, glass spheres, milled glass and/or fibrous fillers and/or reinforcers based on carbon fibres and/or glass fibres. Preference is given to using mineral particulate fillers based on mica, silicate, quartz, wollastonite, kaolin, amorphous silicas, magnesium carbonate, chalk, feldspar, barium sulphate and/or glass fibres. Particular preference is given to using in accordance with the invention mineral particulate fillers based on wollastonite, kaolin and/or glass fibres.

Furthermore, acicular mineral fillers may also be preferably employed. In accordance with the invention the term acicular mineral fillers is to be understood as meaning a mineral filler having a highly pronounced acicular character. Examples include in particular acicular wollastonites.

The mineral filler to be employed as component F) preferably has a length:diameter ratio in the range from 2:1 to 35:1, particularly preferably in the range from 3:1 to 19:1, most preferably in the range from 4:1 to 12:1. The median particle size of the acicular mineral fillers to be employed in accordance with the invention is preferably smaller than 20 μm, particularly preferably smaller than 15 μm, especially preferably smaller than 10 μm, determined with a CILAS GRANULOMETER.

In one embodiment the filler and/or reinforcer to be employed as component F) may be surface modified, preferably with an adhesion promoter/adhesion promoter system, in particular a silane-based adhesion promoter/adhesion promoter system (see above). However, pretreatment in the form of surface modification is not absolutely necessary. Particularly when using glass fibres it is possible also to employ, in addition to silanes, polymer dispersions, film formers, branching agents and/or glass fibre processing aids.

The glass fibres particularly preferred for employment as the filler of component F) in accordance with the invention and having an average fibre diameter generally in the range from 7 to 18 μm, preferably in the range from 9 to 15 μm, are added in the form of chopped or milled glass fibres. The glass fibres are preferably finished with a suitable silane-based size system (see above). See above for average fibre diameter determination.

For processing reasons the fillers to be employed as component F) may have a d97/d50 value that is smaller in the thermoplastic matrix ii) than in the originally employed form. For processing reasons the glass fibres in particular may have length distributions in the thermoplastic matrix ii) that are shorter than originally employed.

The fillers and reinforcers may be employed individually or as a mixture of two or more different fillers and/or reinforcers.

The thermoplastic matrix ii) according to the invention may preferably comprise as component F) di- or polyfunctional branching or chain-extending additives, comprising at least two and no more than 15 branching or chain-extending functional groups per molecule. Suitable branching/chain-extending additives include low-molecular weight or oligomeric compounds comprising at least two and no more than 15 branching or chain-extending functional groups per molecule which are capable of reaction with primary and/or secondary amino groups and/or amide groups and/or carboxylic acid groups. Chain-extending functional groups are preferably isocyanates, alcohols, blocked isocyanates, epoxides, maleic anhydrides, oxazoline, oxazine, oxazolone.

Particularly preferred di- or polyfunctional branching or chain-extending additives are diepoxides based on diglycidyl ethers (bisphenol and epichlorohydrin), based on amine epoxy resin (aniline and epichlorohydrin), based on diglycidyl esters (cycloaliphatic dicarboxylic acids and epichlorohydrin), individually or in mixtures, and also 2,2-bis[p-hydroxyphenyl]propane diglycidyl ether, bis[p-(N-methyl-N-2,3-epoxypropylamino)phenyl]methane and epoxidized fatty acid esters of glycerol comprising at least two and no more than 15 epoxy groups per molecule.

Particularly preferred di- or polyfunctional branching or chain-extending additives are glycidyl ethers, very particularly preferably bisphenol A diglycidyl ether [CAS No. 98460-24-3] or epoxidized fatty acid esters of glycerol, and also very particularly preferably epoxidised soy bean oil [CAS No. 8013-07-8].

Also particularly preferably suitable for branching/chain extension are:

1. Poly- or oligoglycidyl or poly(β-methylglycidyl) ethers, obtainable by reaction of a compound comprising at least two free alcoholic hydroxy groups and/or phenolic hydroxy groups with a suitably substituted epichlorohydrin under alkaline conditions, or in the presence of an acidic catalyst with subsequent alkali treatment.

Poly- or oligoglycidyl or poly(β-methylglycidyl) ethers preferably derive from acyclic alcohols, in particular ethylene glycol, diethylene glycol and higher poly(oxyethylene)glycols, propane-1,2-diol, poly(oxypropylene)glycols, propane-1,3-diol, butane-1,4-diol, poly(oxytetramethylene)glycols, pentane-1,5-diol, hexane-1,6-diol, hexane-2,4,6-trio, glycerol, 1,1,1-trimethylpropane, bistrimethylolpropane, pentaerythritol, sorbitol, or from polyepichlorohydrins.

However, said ethers also preferably derive from cycloaliphatic alcohols, in particular 1,3- or 1,4-dihydroxycyclohexane, bis(4-hydroxycyclohexyl)methane, 2,2-bis(4 hydroxycyclohexyl)propane or 1,1-bis(hydroxymethyl)cyclohex-3-ene, or they comprise aromatic nuclei, in particular N,N-bis(2-hydroxyethyl)aniline or p,p′-bis(2-hydroxyethylamino)diphenylmethane.

The epoxy compounds may also preferably derive from mononuclear phenols, in particular from resorcinol or hydroquinone; or are based on polynuclear phenols, in particular on bis(4-hydroxyphenyl)methane, 2,2-bis(4-hydroxyphenyl)propane, 2,2-bis(3,5-dibromo 4-hydroxyphenyl)propane, 4,4′-dihydroxydiphenylsulphone or on condensation products of phenols with formaldehyde obtained under acidic conditions, in particular phenol novolacs.

2. Poly- or oligo(N-glycidyl) compounds further obtainable by dehydrochlorination of the reaction products of epichlorohydrin with amines comprising at least two amino hydrogen atoms. These amines are preferably aniline, toluidine, n-butylamine, bis(4-aminophenyl)methane, m-xylylenediamine or bis(4-methylaminophenyl)methane, or else N,N,O-triglycidyl-m-aminophenyl or N, N,O-triglycidyl-p-aminophenol.

However the poly(N-glycidyl) compounds also preferably include N,N′-diglycidyl derivatives of cycloalkylene ureas, particularly preferably ethylene urea or 1,3-propylene urea, and N,N′-diglycidyl derivatives of hydantoins, in particular 5,5-dimethylhydantoin.

3. Poly- or oligo(S-glycidyl) compounds, in particular di-S-glycidyl derivatives deriving from dithiols, preferably ethane-1,2-dithiol or bis(4-mercaptomethylphenyl) ether.
4. Epoxidized fatty acid esters of glycerol, in particular epoxidized vegetable oils. Said esters are obtained by epoxidation of the reactive olefin groups of triglycerides of unsaturated fatty acids. Epoxidized fatty acid esters of glycerol may be produced from unsaturated fatty acid esters of glycerol, preferably from vegetable oils, and organic peroxycarboxylic acids (Prilezhaev reaction). Processes for producing epoxidized vegetable oils are described, for example, in Smith, March, March's Advanced Organic Chemistry (5th edition, Wiley-Interscience, New York, 2001). Preferred epoxidized fatty acid esters of glycerol are vegetable oils. An epoxidized fatty acid ester of glycerol which is particularly preferred in accordance with the invention is epoxidized soy bean oil [CAS No. 8013-07-8].

Plasticizers preferred for employment as component F) are dioctyl phthalate, dibenzyl phthalate, butyl benzyl phthalate, hydrocarbon oils or N-(n-butyl)benzene sulphonamide.

Flow assistants preferred for employment as component F) are copolymers of at least one a-olefin and at least one methacrylic ester or acrylic ester of an aliphatic alcohol. Particular preference is given here to copolymers where the a-olefin is formed from ethene and/or propene and the methacrylic ester or acrylic ester contains comprises as the alcohol component linear or branched alkyl groups comprising 6 to 20 carbon atoms. Very particular preference is given to 2-ethylhexyl acrylate. Features of the copolymers suitable as flow assistants in accordance with the invention are not just their composition but also their low molecular weight. Preference is therefore given primarily to copolymers having an MFI value, measured at 190° C. and a load of 2.16 kg, of at least 100 g/10 min, preferably of at least 150 g/10 min, particularly preferably of at least 300 g/10 min. The MFI, melt flow index, is used to characterize the flow of a melt of a thermoplast and is governed by the standards ISO 1133 or ASTM D 123. The MFI, and all values relating to MFI in the context of the present invention, relate to or were measured or determined in uniform fashion as per ISO 1133 at 190° C. with a test weight of 2.16 kg.

Elastomer modifiers preferred for employment as component F) encompass, inter alia, one or more graft polymers of
E.1 5 to 95 wt %, preferably 30 to 90 wt %, of at least one vinyl monomer on
E.2 95 to 5 wt %, preferably 70 to 10 wt %, of one or more graft substrates having glass transition temperatures of <10° C., preferably <0° C., more preferably <−20′C.

The graft substrate E.2 generally has a median particle size (d50) in the range from 0.05 to 10 μm, preferably in the range from 0.1 to 5 μm, particularly preferably in the range from 0.2 to 1 μm.

Monomers E.1 are preferably mixtures of
E.1.1 50 to 99 wt % of vinylaromatics and/or ring-substituted vinylaromatics, in particular styrene, α-methylstyrene, p-methylstyrene, p-chlorostyrene, and/or (C₁-C₈) alkyl methacrylates, in particular methyl methacrylate, ethyl methacrylate, and
E.1.2 1 to 50 wt % of vinyl cyanides, in particular unsaturated nitriles such as acrylonitrile and methacrylonitrile, and/or (C₁-C₈) alkyl(meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide.

Preferred monomers E.1.1 are selected from at least one of the monomers styrene, α-methylstyrene and methyl methacrylate and preferred monomers E.1.2 are selected from at least one of the monomers acrylonitrile, maleic anhydride, glycidyl methacrylate and methyl methacrylate.

Particularly preferred monomers are E.1.1 styrene and E.1.2 acrylonitrile.

Graft substrates E.2 suitable for the graft polymers to be employed in the elastomer modifiers are, for example, diene rubbers, EPDM rubbers, i.e. those based on ethylene/propylene and optionally diene, also acrylate, polyurethane, silicone, chloroprene and ethylene/vinyl acetate rubbers. EPDM stands for ethylene-propylene-diene rubber.

Preferred graft substrates E.2 are diene rubbers, in particular based on butadiene, isoprene etc., or mixtures of diene rubbers or copolymers of diene rubbers or mixtures thereof with further copolymerizable monomers, especially of the type E.1.1 and E.1.2, with the proviso that the glass transition temperature of component E.2 is <10° C., preferably <0° C., particularly preferably <−10° C.

Particularly preferred graft substrates E.2 are ABS polymers (emulsion, bulk and suspension ABS), where ABS stands for acrylonitrile-butadiene-styrene, as described, for example, in DE-A 2 035 390 (=U.S. Pat. No. 3,644,574) or in DE-A 2 248 242 (=GB-A 1 409 275) or in Ullmann, Enzyklopädie der Technischen Chemie, vol. 19 (1980), p. 280 ff. The gel content of the graft substrate E.2 is preferably at least 30 wt %, particularly preferably at least 40 wt % (measured in toluene).

The elastomer modifiers/graft polymers are produced by free-radical polymerization, preferably by emulsion, suspension, solution or bulk polymerization, in particular by emulsion or bulk polymerization.

Particularly suitable graft rubbers are also ABS polymers prepared by redox initiation with an initiator system composed of organic hydroperoxide and ascorbic acid in accordance with U.S. Pat. No. 4,937,285.

Since, as is well known, the graft monomers are not necessarily entirely grafted onto the graft substrate in the grafting reaction, in accordance with the invention graft polymers are also understood to mean products which are produced via (co)polymerization of the graft monomers in the presence of the graft substrate and coobtained in the workup.

Likewise suitable acrylate rubbers are based on graft substrates E.2 which are preferably polymers of alkyl acrylates, optionally with up to 40 wt %, based on E.2, of other polymerizable, ethylenically unsaturated monomers. The preferred polymerizable acrylic esters include C₁-C₈ alkyl esters, preferably methyl, ethyl, butyl, n-octyl and 2-ethylhexyl esters; haloalkyl esters, preferably halo-C₁-C₆ alkyl esters, preferably chloroethyl acrylate, glycidyl esters and mixtures of these monomers. Particular preference is given here to graft polymers comprising butyl acrylate as the core and methyl methacrylates as the shell, in particular Paraloid® EXL2300, from Dow Corning Corporation, Midland Mich., USA.

Further preferentially suitable graft substrates of the type E.2 are silicone rubbers comprising graft-active sites, such as are described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Preferred graft polymers comprising a silicone fraction are those comprising methyl methacrylate or styrene-acrylonitrile as the shell and a silicone/acrylate graft as the core. An example of an employable graft polymer comprising styrene-acrylonitrile as the shell is Metablen® SRK200. Examples of employable graft polymers comprising methyl methacrylate as the shell include Metablen® S2001, Metablen® S2030 and/or Metablen® SX-005. Particular preference is given to employing Metablen® S2001. The products carrying the trade name Metablen® are obtainable from Mitsubishi Rayon Co., Ltd., Tokyo, Japan.

Crosslinking may be achieved by copolymerizing monomers comprising more than one polymerizable double bond. Preferred examples of crosslinking monomers are esters of unsaturated monocarboxylic acids comprising 3 to 8 carbon atoms and of unsaturated monohydric alcohols comprising 3 to 12 carbon atoms or of saturated polyols comprising 2 to 4 OH groups and 2 to 20 carbon atoms, preferably ethylene glycol dimethacrylate, allyl methacrylate; polyunsaturated heterocyclic compounds, preferably trivinyl and triallyl cyanurate; polyfunctional vinyl compounds, preferably di- and trivinylbenzenes, but also triallyl phosphate and diallyl phthalate.

Preferred crosslinking monomers are allyl methacrylate, ethylene glycol dimethacrylate, diallyl phthalate and heterocyclic compounds comprising at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02 to 5 wt %, in particular 0.05 to 2 wt %, based on the graft substrate E.2.

For cyclic crosslinking monomers comprising at least 3 ethylenically unsaturated groups the amount is advantageously restricted to below 1 wt % of the graft substrate E.2.

Preferred “other” polymerizable, ethylenically unsaturated monomers which, in addition to the acrylic esters, may optionally be used to prepare the graft substrate E.2 are acrylonitrile, styrene, a-methylstyrene, acrylamide, vinyl C₁-C₆ alkyl ethers, methyl methacrylate, glycidyl methacrylate, butadiene. Preferred acrylate rubbers employed as graft substrate E.2 are emulsion polymers having a gel content of at least 60% by weight.

In addition to elastomer modifiers based on graft polymers, it is likewise possible to employ elastomer modifiers which are not based on graft polymers and which have glass transition temperatures of <1000, preferably <0° C., particularly preferably <−20° C. These preferably include elastomers having a block copolymer structure, and also thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

Flame retardants preferred for employment as component F) and distinct from component B) are phosphorus-containing flame retardants selected from the group of monomeric and oligomeric phosphoric and phosphonic esters, phosphonates, phosphites distinct from component C), hypophosphites and phosphine oxides.

Other flame retardants or flame retardant synergists not specifically mentioned here may also be employed as component F). These also include purely inorganic phosphorus compounds, in particular red phosphorus or boron phosphate hydrate. Also employable are mineral flame retardant additives or salts of aliphatic and aromatic sulphonic acids, in particular metal salts of 1-perfluorobutanesulphonic acid, preferably sodium perfluoro-1-butanesulphonate and/or potassium perfluoro-1-butanesulphonate, particularly preferably potassium perfluoro-1-butanesulphonate [CAS No. 29420-49-3](for example Bayowet® C4 from Lanxess Deutschland GmbH, Cologne). Also suitable are flame retardant synergists from the group of the oxygen-, nitrogen- or sulphur-containing metal compounds, preferably zinc oxide, zinc stannate, zinc hydroxystannate, zinc sulphide, molybdenum oxide, provided it has not already been employed as a colourant, titanium dioxide, magnesium carbonate, calcium carbonate, calcium oxide, titanium nitride, boron nitride, magnesium nitride, zinc nitride, zinc phosphate, calcium phosphate, calcium borate, magnesium borate or mixtures thereof.

Further preferentially suitable flame retardant additives are char formers, particularly preferably poly(2,6-diphenyl-1,4-phenyl) ether, in particular poly(2,6-dimethyl-1,4-phenylene) ether [CAS No. 25134-01-4], phenol-formaldehyde resins, polycarbonates, polyimides, polysulphones, polyethersulphones or polyetherketones, and antidrip agents, in particular tetrafluoroethylene polymers. The tetrafluoroethylene polymers may be employed in pure form or else in combination with other resins, preferably styrene-acrylonitrile (SAN), or acrylates, preferably methyl methacrylate and/or butyl acrylate. One especially preferentially suitable example of a tetrafluoroethyene-styrene-acrylonitrile resin is Cycolac® INP 449 [CAS No. 1427364-85-9] from Sabic Corp., Riyadh, Saudi Arabia and one especially preferentially suitable example of a tetrafluoroethylene-acrylate resin is Metablen A3800 [CAS No. 639808-21-2] from Mitsubishi Rayon Co., Ltd., Tokyo, Japan. Antidrip agents comprising tetrafluoroethylene polymers are employed in accordance with the invention as component F) preferably in amounts of from 0.01 to I wt %, particularly preferably from 0.1 to 0.6 wt %.

The flame retardants for additional employment as component F) may be added to the polycarbonate in pure form or via masterbatches or compactates during production of the thermoplastic matrix ii).

Further thermal stabilizers distinct from components B) and C) are selected from the group of sulphur-containing stabilizers, in particular sulphides, dialkylthiocarbamates and thiodipropionic acids, also those selected from the group of copper salts, in particular copper(I) iodide, which are/is preferably employed in combination with potassium iodide and/or sodium hypophosphite NaH₂PO₂, also sterically hindered amines, in particular tetramethylpiperidine derivatives, aromatic secondary amines, in particular diphenylamines, hydroquinones, substituted resorcinols, salicylates, benzotriazoles and benzophenones, and variously substituted representatives of these groups.

Preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 96.999 wt % of polycarbonate,
B) 3 to 38 wt % of one or more phosphazenes of formula (I) and/or one or more phosphazenes of formula (II),

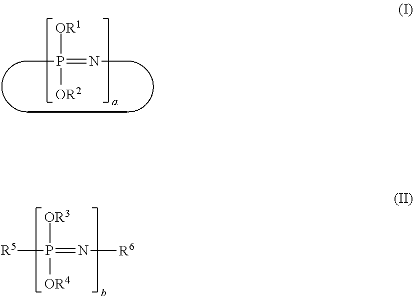

where
R¹, R², R³, R⁴, R⁵, R⁶, a and b are as defined above and
C) 0.001 to 2 wt % of a thermal stabilizer from the group of aliphatically or aromatically substituted phosphites preferably having a molecular weight greater than 650 g/mol, wherein the sum of the percentages by weight in the thermoplastic matrix ii) always amounts to 100 and wherein the fibrous material i) is impregnated with the thermoplastic matrix ii) and the volume fraction of the fibrous material i) in the fibre-matrix semifinished product is in the range from 25 to 65 vol %.

Further preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 96.999 wt % of polycarbonate,
B) 3 to 37 wt % of one or more organic phosphazenes of formula (I) and/or one or more phosphazenes of formula (II),

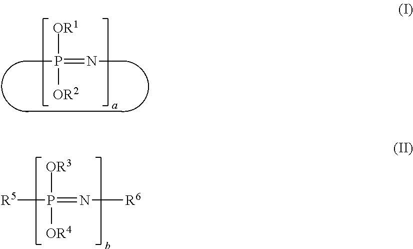

where
R¹, R², R³, R⁴, R⁵, R⁶, a and b are as defined above and
D) 0.001 to 3 wt % of a thermal stabilizer selected from the group of sterically hindered phenols preferably having a molecular weight greater than 600 g/mol, wherein the sum of the percentages by weight in the thermoplastic matrix ii) always amounts to 100 and wherein the fibrous material i) is impregnated with the thermoplastic matrix ii) and the volume fraction of the fibrous material i) in the fibre-matrix semifinished product is in the range from 25 to 65 vol %.

Particularly preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 96&999 wt % of polycarbonate,
6) 3 to 38 wt % of one or more phosphazenes of formula (I),

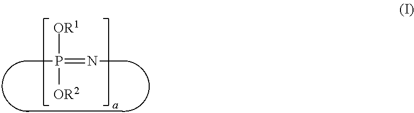

where R¹, R² represent phenyl and a is an integer from 3 to 8, and
C) 0.001 to 2 wt % of a thermal stabilizer from the group of aliphatically, partially aliphatically or aromatically substituted phosphites preferably having a molecular weight greater than 650 g/mol, wherein the sum of the percentages by weight in the thermoplastic matrix ii) always amounts to 100 and wherein the fibrous material i) is impregnated with the thermoplastic matrix ii) and the volume fraction of the fibrous material i) in the fibre-matrix semifinished product is in the range from 25 to 65 vol %,

Very particularly preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 96.998 wt % of polycarbonate,
B) 3 to 35 wt % of one or more phosphazenes of formula (I),

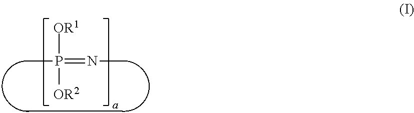

where R¹, R² in each case represent phenyl and a is an integer from 3 to 8,
C) 0.001 to 2 wt % of a thermal stabilizer from the group of aliphatically, partially aliphatically or aromatically substituted phosphites preferably having a molecular weight greater than 650 g/mol, and
D) 0.001 to 3 wt % of at least one thermal stabilizer selected from the group of sterically hindered phenols preferably having a molecular weight greater than 600 g/mol, wherein the fibrous material i) is impregnated with the thermoplastic matrix ii) and the volume fraction of the fibrous material i) in the fibre-matrix semifinished product is in the range from 25 to 65 vol %, wherein the sum of the percentages by weight in the thermoplastic matrix ii) always amounts to 100.

Very particularly preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 96.988 wt % of polycarbonate,
6) 3 to 30 wt % of one or more phosphazenes of formula (I),

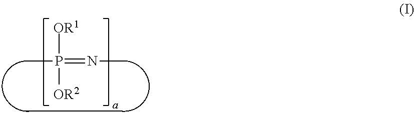

where R¹, R² represent phenyl and a is an integer from 3 to 8,
C) 0.001 to 2 wt % of a thermal stabilizer from the group of aliphatically or aromatically substituted phosphites preferably having a molecular weight greater than 650 g/mol,
D) 0.001 to 3 wt % of at least one thermal stabilizer selected from the group of sterically hindered phenols preferably having a molecular weight greater than 600 g/mol, and
E) 061 to 5 wt % of at least one lubricating and demoulding agent selected from pentaerythritol tetrastearate and ethylene glycol dimontanate, wherein the sum of the percentages by weight in the thermoplastic matrix ii) always amounts to 100 and wherein the fibrous material i) is impregnated with the thermoplastic matrix and the volume fraction of the fibrous material i) in the fibre-matrix semifinished product is in the range from 25 to 65 vol %,

Especially particularly preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 84.86 wt % of polycarbonate,
6) 15 to 38.4 wt % of one or more phosphazenes of formula (I),

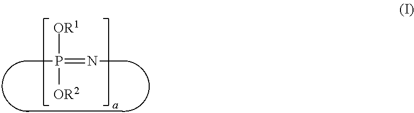

where R¹, R² represent phenyl and a is an integer from 3 to 8,
C) 0.02 to 0.5 wt % of tetrakis(2,4-di-tert-butylphenyl)-1,1-biphenyl-4,4′-diylbisphosphonite,
D) 0.02 to 0.5 wt % of 3,9-bis[2-[3-(3-tert-butyl-4-hydroxy-1-methylphenyl)propionyloxy]1,1-dimethylethyl]-2,4,8,10-tetraoxaspiro[5.5]undecane, and
E) 0.1 to 0.6 wt % of pentaerythritol tetrastearate wherein the sum of the percentages by weight in the thermoplastic matrix ii) always amounts to 100 and wherein the fibrous material i) is impregnated with the thermoplastic matrix ii) and the volume fraction of the fibrous material i) in the fibre-matrix semifinished product is in the range from 25 to 65 vol %.

Especially very particularly preferred are fibre-matrix semifinished products comprising
i) at least one fibrous material selected from the group of laids, wovens, braids, drawn-loop knits, nonwovens, rovings, mats, stitched fabrics and combinations thereof, made of glass fibres, carbon fibres, mineral fibres, natural fibres, polymeric fibres and/or combinations thereof, and
   a thermoplastic matrix ii) comprising
A) 60 to 84.86 wt % of polycarbonate,
B) 15 to 38.4 wt % of one or more phosphazenes of formula (I),

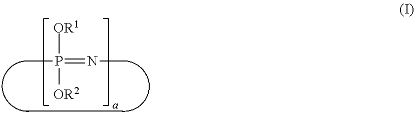

where R¹, R² represent phenyl and a is an integer from 3 to 8,
C) 0.02 to 0.5 wt % of tetrakis(2,4-di-tert-butylphenyl)-1,1-biphenyl-4,4′-diylbisphosphonite,
D) 0.02 to 0.5 wt % of 3,9-bis[2-[3-(3-tert-butyl-4-hydroxy-5-methylphenyl)propionyloxy]-1,1-dimethylethyl]-2,4,8,10-tetraoxaspiro[5.5]undecane, and
E) 0.1 to 0.6 wt % of pentaerythritol tetrastearate wherein the sum of the percentages by weight in the thermoplastic matrix ii) always amounts to 100 and wherein the fibrous material i) is impregnated with the thermoplastic matrix ii) and the volume fraction of the fibrous material i) in the fibre-matrix semifinished product is in the range from 25 to 65 vol %,

### Process

Fibre-matrix semifinished products according to the invention are produced by impregnating the fibrous material i) with the thermoplastic matrix ii).

This preferably comprises pressing the components of the thermoplastic matrix ii) with the fibrous material i) at temperatures above the melting point of component A). The components of the thermoplastic matrix ii) may be in the form of a mixture and the solid individual components are preferably comminuted to median particle sizes smaller than 500 μm using customary commination methods known to those skilled in the art beforehand, i.e. prior to the pressing operation.

It is particularly preferable when the individual components of the thermoplastic matrix ii) are compounded in an upstream step wherein, preferably at temperatures in the range from 270° C. to 330° C., the individual components are mixed in a twin-screw extruder and extruded. The still-hot extrudate may either be transferred directly in liquid form into the apparatus for impregnating the fibrous material or else cooled until pelletizable and pelletized. In the case of the latter process the pellets for impregnating the fibrous material i) may be milled in a further step prior to the impregnation process, median particle sizes of <500 μm being preferred and median particle sizes of <300 μm being particularly preferred. See above for median particle size determination.

Impregnation of the thermoplastic fibre-matrix semifinished product according to the invention is achieved using processes known from the prior art.

In accordance with the invention the fibrous material i) in the fibre-matrix semifinished product has a fibre volume fraction in the range from 25 to 65 vol %, preferably in the range from 30 to 60 vol %, particularly preferably in the range from 40 to 55 vol %, the total volume of the semifinished product being 100. The fibre volume fraction is thus the percentage volume fraction of the fibrous material i) in the fibre-matrix semifinished product. Said fraction may be calculated in simple fashion from the density of the thermoplastic matrix and the density of the fibrous material i) which is known from the literature. This density of the thermoplastic matrix ii) may be determined according to ISO1183 for example.

It is also possible to construct the fibre-matrix semifinished product in sandwich fashion by combining different fibrous materials i) for employment in accordance with the invention with different inventive versions of the thermoplastic matrix ii). It is preferable in this case to achieve impregnation by hot-pressing with identical or different layers of fibrous materials i) with identical or different layers of the thermoplastic matrix ii).

Impregnation is carried out under elevated pressure at temperatures preferably above the melting point of component A), particularly preferably at temperatures in the range from 270° C. to 330° C., very particularly preferably in the range from 290° C. to 320° C., using hot presses or heated rollers in particular. Impregnation is known to those skilled in the art from EP1923420 A1 for example.

The fibre-matrix semifinished product obtained from the pressing operation may subsequently be subjected to further processing by forming in accordance with the above described prior art.

Also possible is subsequent application of further layers or spray application of further functional elements by injection moulding onto the fibre-matrix semifinished product according to the invention and also subsequent coating of the fibre-matrix semifinished product according to the invention.

### Use

The present invention also relates to the use of the fibre-matrix semifinished products according to the invention in components subject to increased flame retardancy requirements, preferably as components subject to mechanical loads for IT equipment, in particular in notebooks, mobile telephones or tablet computers, as a casing material for electrical or electronic parts, as fittings for shielding, inter alia, short-circuit induced arc flash in circuit breakers and generally as a flame barrier in buildings, passenger vehicles, commercial vehicles, in shipping applications and in means of public transport, for example in rail vehicles and buses. Use in IT equipment is particularly preferred.

The present invention is more particularly elucidated with the aid of the following examples. However, there is no intention whatsoever for said examples to be seen as limiting.

### Examples

### Fibre-Matrix Semifinished Products

The fibre-matrix semifinished products falling within the scope of the present invention were produced by hot-pressing fibre material and thermoplast matrix at temperatures in the range from 290° C. bis 320° C. The material thickness is thus a function of the number of fibre material layers and the desired fibre volume fraction.

The thermoplast matrix ii) was fabricated by compounding before being processed into the fibre-matrix semifinished product. To this end, the individual components were mixed in a twin-screw extruder (ZSK 25 Compounder from Coperion Werner & Pfleiderer (Stuttgart, Germany)) at temperatures in the range from 290° C. to 310° C. and the resulting mixture was extruded, cooled until pelletizable, pelletized and subsequently milled.

The flame retardancy of the fibre-matrix semifinished products was determined according to method UL94V (Underwriters Laboratories Inc. Standard of Safety, “Test for Flammability of Plastic Materials for Parts in Devices and Appliances”, p. 14 to p. 18 Northbrook 1998). Specimens having the dimensions 125 mm·13 mm in thicknesses of 0.5 mm, 0.8 mm and 2.0 mm were cut out of the prefabricated fibre-matrix semifinished products using a waterjet cutting apparatus. A composition meeting the criteria according to UL94 V-0 is given the corresponding designation “class V-0: yes”. If as a result of excessively long after flame times or burning drips only class V-1, V-2 or “failure” is achieved the corresponding composition is labelled “Class V-0: no”.

Mechanical characteristics were obtained from flexural experiments as per ISO 178. The specimens used therefor and having the dimensions 80 mm·10 mm·2.0 mm were cut out of the prefabricated fibre-matrix semifinished products using a waterjet cutting apparatus. The experiments employed:

### Fibrous Material i):

FG: 2/2 twill weave made of filament glass with silane size and a basis weight of 290 g/m². The glass employed had a density of 2.56 g/cm.
CF: 2/2 twill weave made of carbon fibre with a basis weight of 200 g/m². The carbon fibre employed had a density of 1.8 g/cm³.

### Thermoplastic Matrix ii)

Component A1) linear polycarbonate (Makrolon® 2805 from Bayer MaterialScience AG, Leverkusen, Germany) based on Bisphenol A and having a viscosity ηᵣₑₗ of about 1.29 (test conditions: 5 g of polycarbonate per litre of methylene chloride, 250° C.) and an average molecular weight Mw of about 29 000 g/mol (determined by GPC methods against a polycarbonate standard)
Component B1) phenoxyphosphazene oligomer employed [CAS No. 1203646-63-2](Rabitle® FP110 from Fushimi Pharmaceutical Co. Ltd, Kagawa, Japan)
Component X1) tetrakis(2,6-dimethylphenyl)-m-phenylbisphosphate, [CAS-Nr. 139189-30-3](PX-200 from Daihachi Chemical Industry Co., Ltd., Osaka, Japan)
Component X2) potassium perfluoro-1-butanesulphonate [CAS-Nr. 29420-49-3] (Bayowet® C4 from Lanxess Deutschland GmbH, Cologne, Germany)
Component C1) tetrakis(2,4-di-tert-butylphenyl)-1,1-biphenyl-4,4′-diylbisphosphonite [CAS No. 38613-77-3](Hostanox® P-EPQ from Clariant International Ltd., Muttenz, Switzerland)
Component D1) 3,9-bis[2-[3-(3-tert-butyl-4-hydroxy-5-methylphenyl)propionyloxy]1,1-dimethylethyl]-2,4,8,10-tetraoxaspiro[5.5]undecane [CAS No. 90498-90-1](ADK STAB AO 80 from Adeka-Palmerole, Mulhouse, France)
Component E) pentaerythritol tetrastearate [CAS No. 115-83-3](Loxiol® P 861 from Emery Oleochemicals GmbH, Düsseldorf, Germany)

TABLE 1
Thermoplastic matrix ii) employed in the examples
and comparative examples designated M1 to M4

| | | M1 | M2 | M3 | M4 |
|---|---|---|---|---|---|
| component A1 | [%] | 79.84 | 69.84 | 79.84 | 99.79 |
| component B1 | [%] | 20 | 30 | | |
| component X1 | [%] | | | 20 | |
| component X2 | [%] | | | | 0.05 |
| component C1 | [%] | 0.02 | 0.02 | 0.02 | 0.02 |
| component D1 | [%] | 0.04 | 0.04 | 0.04 | 0.04 |
| component E | [%] | 0.1 | 0.1 | 0.1 | 0.1 |

TABLE 2
Thermoplastics fibre-matrix semifinished product

| | | Ex. 1 | Ex. 2 | Ex. 3 | Ex. 4 | Ex. 5 | Comp. 1 | Comp. 2 |
|---|---|---|---|---|---|---|---|---|
| matrix ii) | | M1 | M1 | M1 | M1 | M2 | M3 | M4 |
| fibre material i) | | CF | CF | CF | FG | CF | CF | CF |
| fibre volume | [vol %] | 45 | 50 | 57 | 50 | 45 | 45 | 45 |
| fraction | | | | | | | | |
| UL94 at 0.5 mm | class V-0 | yes | — | — | — | — | — | — |
| UL94 at 0.8 mm | class V-0 | yes | — | yes | — | — | — | — |
| UL94 at 2.0 mm | class V-0 | yes | yes | — | yes | yes | no | no |
| flexural modulus | GPa | 45 | 50 | — | 21 | — | — | — |
| flexural strength | MPa | 600 | 650 | — | 480 | — | — | — |

The examples and comparative examples in Table 2 show that when using a combination of thermoplast matrix ii) for employment in accordance with the invention a UL94 classification of V-0 was achieved for various wall thicknesses both in the case of the glass fibre fabrics FG for employment in accordance with the invention and in the case of the carbon fibre fabrics CF for employment in accordance with the invention. This is the case for a wide range of different fibre volume fractions. These flame classifications were not achieved in the case of a noninventive polymer matrix (Comp. 1 and Comp. 2).

What is claimed:

1. A fibre-matrix product having increased flame-retardancy, the fibre-matrix product comprising:
i) at least one fibrous material; and
ii) a thermoplastic matrix comprising:
A) 10 to 97 wt % of at least one thermoplast from the group of polycarbonates, and
B) 3 to 90 wt % of at least one of:
one or more phosphazenes of formula (I) 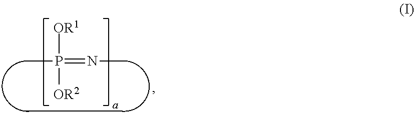
and
one or more phosphazenes of formula (II), 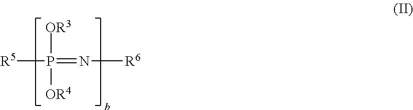
where
R¹, R² are identical or different and represent alkyl, cycloalkyl, aryl or alkylaryl,
R³, R⁴ are identical or different and represent alkyl, cycloalkyl, aryl or alkylaryl,
R⁵ represents —N═P(OR³)₃, —N═P(OR⁴)₃, —N═P(O)OR³ or —N═P(O)OR⁴,
R⁶ represents —N═P(OR³)₄, —N═P(OR⁴)₄, —N═P(O)(OR²)₂ or —N═P(O)(OR⁴)₂,
a is an integer from 3 to 25, and
b is an integer from 3 to 10 000,
wherein the sum of the percentages by weight of components A) and B) in the thermoplastic matrix ii) always amounts to 100 and wherein the fibrous material i) is intermixed with the thermoplastic matrix ii) and a volume fraction of the fibrous material i) in the fibre-matrix product is 25 to 65 vol %.

2. The fibre-matrix product according to claim 1, wherein the polycarbonates are homopolycarbonates end/or copolycarbonates based on the bisphenols of general formula (IV),
HO—Z—OH (IV)
where Z is a divalent organic radical comprising 6 to 30 carbon atoms and one or more aromatic groups.

3. The fibre-matrix product according to claim 2, wherein the polycarbonates are based on bisphenols of formula (IVa) 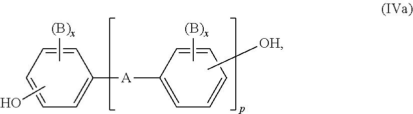
where
A represents a single bond or a radical from the set C₁-C₅ alkylene, C₂-C₅ alkylidene, C₅-C₅ cycloalkylidene, —O—, —SO—, —CO—, —S—, —SO₂—, arylene, onto which further aromatic rings optionally containing heteroatoms may be fused, or a radical of formula (V) or (VI) 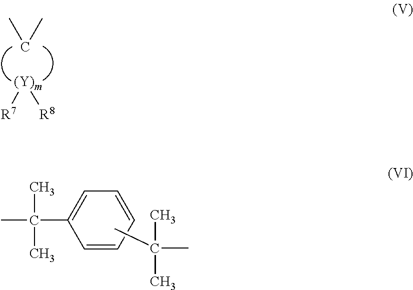
where R⁷ and R⁸ are individually selectable for each V and independently of one another represent hydrogen or C₁-C₈ alkyl,
B in each case represents C₁-C₁₂ alkyl,
x is in each case independently of one another 0, 1 or 2,
p is 1 or 0,
Y represents carbon, and
m is an integer from 4 to 7, with the proviso that on at least one carbon atom Y, R⁷ and R⁸ are both alkyl.

4. The fibre-matrix product according to claim 1, wherein R¹, R², R³ and R⁴ represent aryl and/or alkylaryl.

5. The fibre-matrix product according to claim 1, wherein component B comprises phosphazenes of formula (I) where a is an integer of 3 to 8.

6. The fibre-matrix product according to claim 1, wherein component B comprises phosphazenes of formula (II) where b is an integer of 3 to 1000.

7. The fibre-matrix product according to claim 1, further comprising, in addition to the components A) and B), component C) 0.001 to 2 wt % of at least one thermal stabilizer from the group of aliphatically or aromatically substituted phosphites, wherein at least one of the components A) or B) is to be varied within the scope of the specified ranges such that the sum of all percentages by weight for the components A), B) and C) based on the thermoplastic matrix ii) always amounts to 100.

8. The fibre-matrix product according to claim 7, wherein the molecular weight of the thermal stabilizer is greater than 650 g/mol.

9. The fibre-matrix product according to claim 7, wherein component C) comprises aliphatically substituted phosphites comprising a structural building block of formula (VII), wherein Fe represents substituted aryl radicals which may be identical or different from one another.

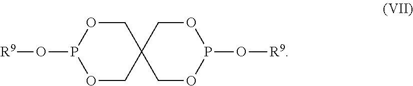

10. The fibre-matrix product according to claim 7, wherein component C) is bis(2,4-dicumylpheny)pentaerythritol diphosphite or tetrakis(2,4-di-tert-butylphenyl)-1,1-biphenyl-4,4′-diylbisphosphonite.

11. The fibre-matrix product according to claim 1, wherein the thermoplastic matrix ii) further comprises, in addition to components A), B) and C), or in place of C), D) 0.001 to 3 wt % of at least one thermal stabilizer selected from the group of sterically hindered phenols, wherein said phenols are compounds having a phenolic structure which comprise at the phenolic ring at least one sterically demanding group and wherein the sum of all the percentages by weight for the components A), B), C), D) or A), B), D) based on the thermoplastic matrix ii) always amounts to 100.

12. The fibre-matrix product according to claim 11, wherein the sterically hindered phenols are compounds comprising at least one molecular building block of formula (IX), 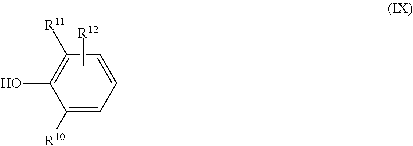
where R¹⁰ and R¹¹ represent an alkyl group, a substituted alkyl group or a substituted triazole group, wherein the radicals R¹⁰ and R¹¹ may be identical or different and R¹² represents an alkyl group, a substituted alkyl group or an optionally substituted alkoxy group.

13. A process for producing the fibre-matrix product according to claim 1, the process comprising impregnating the fibrous material i) with the thermoplastic matrix ii).

14. A method for producing components of articles of manufacture having increased flame retardancy, the method comprising producing the components with the fibre-matrix product according to claim 1, wherein the components include components subject to mechanical loads for IT equipment, casing material for electrical or electronic parts, fittings for shielding, and flame barriers in buildings, passenger vehicles, commercial vehicles, in shipping applications and in means of public transport.

15. The fibre-matrix semi-finished product according to claim 1, wherein:
the at least one fibrous material is selected from the group of laids, wovens, braids, drawn-loop knits, nonwovens, rovings, mats, stitched fabrics and combinations thereof, made of glass fibres, carbon fibres, mineral fibres, natural fibres, polymeric fibres, and combinations thereof;
the thermoplastic matrix comprises:
A) 20 to 90 wt %, of the at least one thermoplasts from the group of polycarbonates, and
B) 10 to 35 wt %, of the at least one of:
the one or more phosphazenes of formula (I), and
the one or more phosphazenes of formula (II);
the fibrous material i) is impregnated with the thermoplastic matrix; and
the volume fraction of the fibrous material i) in the fibre-matrix product is 30 to 60 vol %.

16. The fibre-matrix semifinished product according to claim 15, wherein:
the polycarbonates are based on bisphenols of formula (IVa) 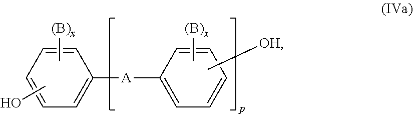
where
A represents a single bond or a radical from the set C₁-C₅ alkylene, C₂-C₅ alkylidene, C₅-C₈ cycloalkylidene, —O—, —SO—, —CO—, —S—, —SO₂—, —C, arylene, onto which further aromatic rings optionally containing heteroatoms may be fused, or a radical of formula (V) or (VI) 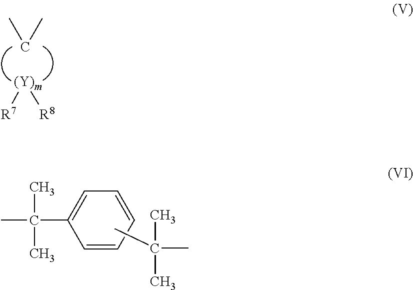
where R⁷ and R⁸ are individually selectable for each Y and independently of one another represent hydrogen, methyl or ethyl,
B in each case represents methyl, chlorine or bromine,
x is in each case independently of one another 0, 1 or 2,
p is 1 or 0,
Y represents carbon, and
m is an integer from 4 to 7, with the proviso that on at least one carbon atom Y, R⁷ and R⁸ are both alkyl;
R¹, R², R³ and R⁴ represent aryl and/or alkylaryl, wherein the aryl groups are phenyl, methylphenyl, dimethylphenyl, trimethylphenyl and/or naphthyl; and
for the phosphazenes, a is an integer of 3 to 8, and b is an integer of 3 to 1000.

17. The fibre-matrix semi-finished product according to claim 16, wherein:
the volume fraction of the fibrous material i) in the fibre-matrix product is 40 to 55 vol %.
the thermoplastic matrix comprises:
A) 35 to 82 wt %, of the at least one thermoplasts from the group of polycarbonates, and
B) 18 to 32 wt %, of the at least one of:
the one or more phosphazenes of formula (I), and
the one or more phosphazenes of formula (II); and
at least one of:
C) 0.001 to 2 wt % of at least one thermal stabilizer from the group of aliphatically or aromatically substituted phosphites, and
D) 0.001 to 3 w % of at least one thermal stabilizer selected from the group of sterically hindered phenols;
wherein the sum of all the percentages by weight for the components A), B), C), or A), B), D) or A), B), C), D), based on the thermoplastic matrix ii) always amounts to 100.

18. The fibre-matrix semi-finished product according to claim 17, wherein:
component C) is bis(2,4-dicumylphenyl)pentaerthritol diphosphite or tetrakis(2,4-di-tert-butylphenyl)-1,1-biphenyl-4,4′-diylbisphosphonite; and
component D) is a compound comprising at least one molecular building block of formula (IX), 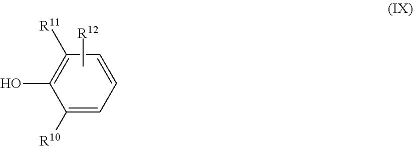
where R¹⁰ and R¹¹ represent an alkyl group, a substituted alkyl group or a substituted triazole group, wherein the radicals R¹⁰ and R¹¹ may be identical or different, and R¹² represents an alkyl group, a substituted alkyl group or an optionally substituted alkoxy group.
